(19) United States
(12) Patent Application Publication
(10) Pub. No.: US 2025/0240134 A1
(43) Pub. Date: Jul. 24, 2025

(54) UNIFIED TCI UPDATES FOR MTRP INCLUDING SIMULTANEOUS BFR

(71) Applicant: InterDigital Patent Holdings, Inc., Wilmington, DE (US)

(72) Inventors: Jonghyun Park, Syosset, NY (US); Afshin Haghighat, Ile-Bizard (CA); Loic Canonne-Velasquez, Dorval (CA); Moon IL Lee, Melville, NY (US); Paul Marinier, Brossard (CA); Virgil Comsa, Montreal (CA)

(73) Assignee: InterDigital Patent Holdings, Inc., Wilmington, DE (US)

(21) Appl. No.: 18/850,307

(22) PCT Filed: Mar. 27, 2023
(86) PCT No.: PCT/US2023/016418

§ 371 Date: Sep. 24, 2024

Related U.S. Application Data
(60) Provisional application No. 63/326,683, filed on Apr. 1, 2022.
(60) Provisional application No. 63/395,563, filed on Aug. 5, 2022.
(60) Provisional application No. 63/411,247, filed on Sep. 29, 2022.
(60) Provisional application No. 63/445,555, filed on Feb. 14, 2023.

(51) Int. Cl. H04L 5/00; H04B 7/06; H04W 72/21

(52) U.S. Cl. CPC H04L 5/0044; H04B 7/06964; H04W 72/21

(57) ABSTRACT

A Wireless Transmit/Receive Unit (WTRU) may receive information indicating that a first CORESET that is associated with a first TCI state instance and a second CORESET that is associated with a second TCI state instance. The WTRU may receive a DCI comprising a TCI field indicating a TCI value. The WTRU may use the first TCI state to monitor for the PDCCH transmission in the first CORESET when the TCI value indicates that the first TCI state is associated with the first TCI state instance and when the first CORESET is associated with the first TCI state instance. The WTRU may use the second TCI state to monitor for the PDCCH transmission in the second CORESET when the TCI value indicates that the second TCI state is associated with the second TCI state instance and when the second CORESET is associated with the second TCI state instance.

### CROSS-REFERENCE TO RELATED APPLICATIONS

This application claims the benefit of U.S. Provisional Patent Application No. 63/326,683, filed on Apr. 1, 2022, and to U.S. Provisional Patent Application No. 63/395,563, filed on Aug. 5, 2022, and to U.S. Provisional Patent Application No. 63/411,247, filed on Sep. 29, 2022, and to U.S. Provisional Patent Application No. 63/445,555, filed on Feb. 14, 2023, the entire contents of which are incorporated herein by reference.

### TECHNICAL FIELD

Aspects of the present disclosure relate to wireless communications, and more particularly, to techniques for performing transmission configuration indicator (TCI) and/or beam failure recovery (BFR).

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipment (UE). In an LTE or LTE-A network, a set of one or more base stations may define an eNodeB (eNB). In other examples, a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of WTRUs on downlink channels (e.g., for transmissions from a BS or DU to a WTRU) and uplink channels (e.g., for transmissions from a WTRU to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To this end, NR supports beamforming, multiple-input multiple-output (MIMO) antenna technology, and carrier aggregation.

As the demand for mobile broadband access continues to increase, however, there is a need for further improvements in NR and LTE technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to one exemplary aspect, the disclosure relates to a Wireless Transmit/Receive Unit (WTRU) that includes a processor and memory, that is configured to receive information indicating that a first control resource set (CORESET) is associated with a first transmission configuration indicator (TCI) state instance and a second CORESET is associated with a second TCI state instance. According to an exemplary aspect, the WTRU is configured to receive a downlink control information (DCI) comprising a TCI field indicating a TCI value. In an example, the WTRU maybe configured to monitor for a physical downlink control channel (PDCCH) transmission via at least one of the first CORESET or the second CORESET, wherein a first TCI state is used to monitor for the PDCCH transmission in the first CORESET when the TCI value indicates that the first TCI state is associated with the first TCI state instance and when the first CORESET is associated with the first TCI state instance, and wherein a second TCI state is used to monitor for the PDCCH transmission in the second CORESET when the TCI value indicates that the second TCI state is associated with the second TCI state instance and when the second CORESET is associated with the second TCI state instance.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating a parameter for monitoring DCIs.

FIG. 3. is an example configuration of a UL-TCI IE.

FIG. 4 is a diagram illustrating an example unified TCI(s) with M-TRP across multiple BWPs and/or CCs.

FIG. 5 is a diagram illustrating an example unified TCI(s) with M-TRP across multiple BWPs and/or CCs.

FIG. 6 is a diagram illustrating an example unified TCI(s) with M-TRP across multiple BWPs and/or CCs.

FIG. 7 is a diagram illustrating an example unified TCI(s) with M-TRP across multiple BWPs and/or CCs.

FIG. 8 is a diagram illustrating an example unified TCI(s) with M-TRP across multiple BWPs and/or CCs.

FIG. 9 is a diagram illustrating an example of a TCI field table for a DCI.

FIG. 10 is a diagram illustrating an example of a TCI-codepoint-wise Tx/Rx scheme selection table.

FIG. 11 is a diagram illustrating an example physical downlink control channel (PDCCH) TCI state usage that associates a control resource set (CORESET) with a TCI state instance.

### DETAILED DESCRIPTION

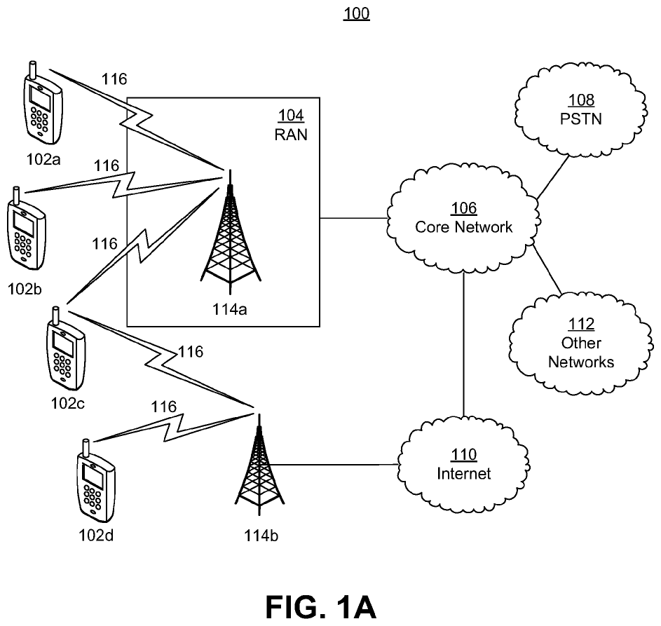

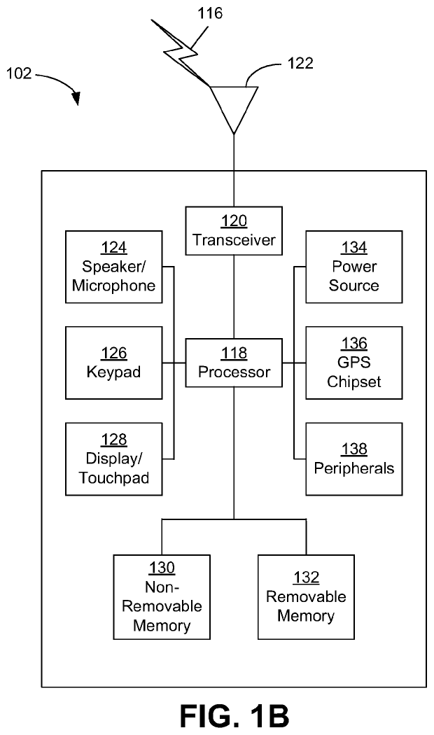

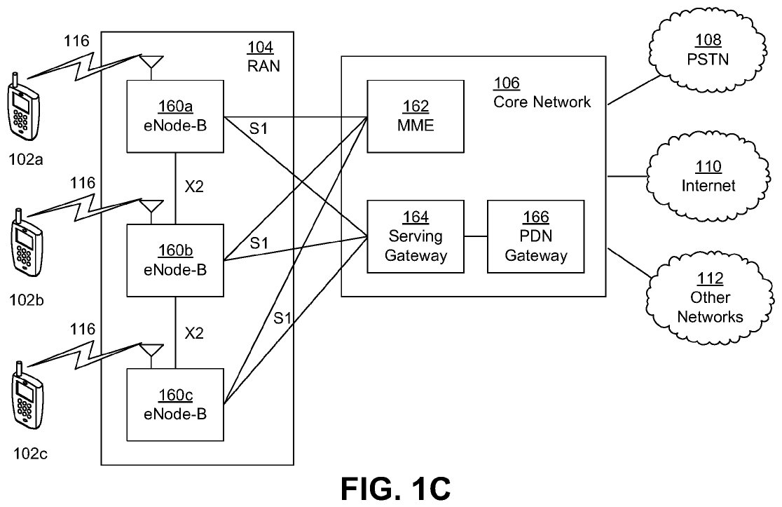

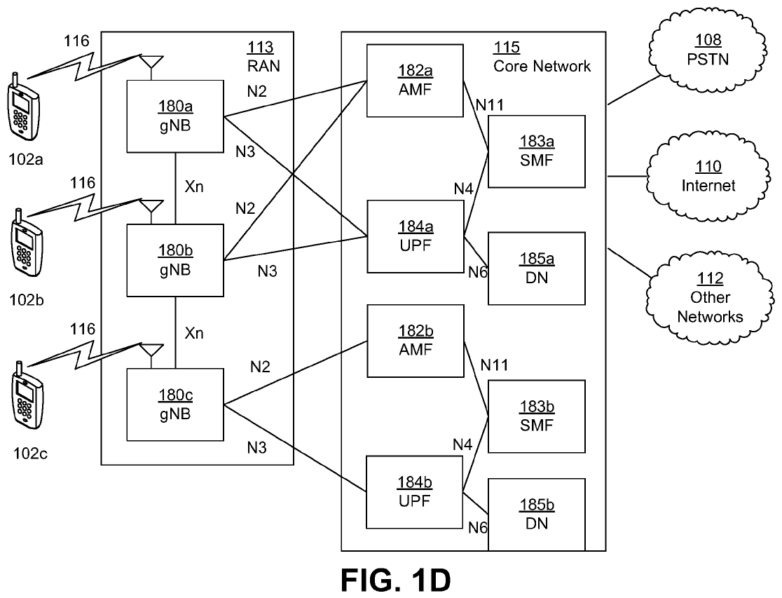

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 1020, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (for example, associated with particular subframes for both the UL (for example, for transmission) and downlink (for example, for reception) may be concurrent and/or simultaneous. The full duplex radio may include an interference management unit 139 to reduce and or substantially eliminate self-interference via either hardware (for example, a choke) or signal processing via a processor (for example, a separate processor (not shown) or via processor 118). In an embodiment, the WRTU 102 may include a half-duplex radio for which transmission and reception of some or all of the signals (for example, associated with particular subframes for either the UL (for example, for transmission) or the downlink (for example, for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHZ channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (for example, handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (for example, an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. Herein, a sign, symbol, or mark of forward slash ‘/’ may be interpreted as ‘and/or’ unless particularly mentioned otherwise, where for example, ‘A/B’ may imply ‘A and/or B’.

A WTRU may transmit or receive at least one physical channel or reference signal, according to at least one spatial domain filter. The term “beam” may be used to refer to a spatial domain filter. The WTRU may transmit a physical channel or a signal using the same spatial domain filter as the spatial domain filter used for receiving a Reference Signal (RS) (for example, a Channel State Information RS (CSI-RS) or a Synchronization Signal (SS) block. The WTRU transmission may be referred to as “target”. The received RS or SS block may be referred to as “reference” or “source”. In an example, a WTRU may transmit a target physical channel and/or signal according to a spatial relation with a reference to a RS and/or a SS block.

In an embodiment, a WTRU may transmit a first physical channel and/or signal according to the same spatial domain filter as the spatial domain filter used for transmitting a second physical channel and/or signal. A first transmission may be referred to as “target”. A second transmission may be referred to as “reference” and/or “source”. A WTRU may transmit the first physical channel or signal (for example, the target physical channel and/or signal) according to a spatial relation with a reference to the second physical channel and/or signal (for example, the reference physical channel and/or signal).

A spatial relation may be implicit, configured by a Radio Resource Control (RRC) and/or signaled by a MAC control element (MAC CE) and/or a Downlink Control Information (DCI). For example, a WTRU may implicitly transmit a physical uplink shared channel (PUSCH) and/or a Demodulation Reference Signal (DM-RS) of a PUSCH according to the same spatial domain filter as a Sounding Reference Signal (SRS) indicated by an SRS resource indicator (SRI) indicated in a DCI and/or configured by a Radio Resource Control (RRC). In an example, a spatial relation may be configured by a RRC for an SRI and/or signaled by a MAC CE for a physical uplink control channel (PUCCH). Such spatial relation may be referred to as a “beam indication”.

The WTRU may receive a first (target) downlink channel or signal according to the same spatial domain filter or spatial reception parameter as a second (reference) downlink channel or signal. For example, an association may exist between a physical channel such as a Physical Downlink Control Channel (PDCCH) and/or a physical downlink shared channel (PDSCH) and its respective DM-RS. In an example, when the first and/or second signals are reference signals, an association may exist when the WTRU is configured with a quasi-colocation (QCL) assumption type D between corresponding antenna ports. In an example, an association may be configured as a transmission configuration indicator (TCI) state. The WTRU may indicate an association between a CSI-RS and/or SS block and a DM-RS, for example, by an index to a set of TCI states configured by RRC and/or signaled by MAC CE. Such indication may be referred to as a “beam indication”.

Herein, “RS” may be interchangeably used with one or more of “RS resource,” “RS resource set,” “RS port” and/or “RS port group,” while remaining consistent with an embodiment. Herein, “RS” may be interchangeably used with one or more of “Synchronization Signal Block” or “SSB,” “CSI-RS,” “SRS,” and/or “DM-RS,” while remaining consistent with an embodiment.

A unified TCI (for example, a common TCI, a common beam, a common RS, and/or the like) may refer to a beam and/or RS to be used for multiple physical channels and/or signals. In an example, a unified TCI may refer to a beam and/or RS to be simultaneously used for multiple physical channels and/or signals. The term “TCI” may comprise at least a TCI state that includes at least one source RS that may provide a reference (for example, WTRU assumption), which may determine a QCL and/or a spatial filter.

In an example, the WTRU may receive (for example, from a gNB) an indication of a first unified TCI that may be used and/or applied for one or both of a PDCCH and a PDSCH (for example, and a downlink RS, as well). The one or more source reference signal(s) in the first unified TCI may provide common QCL information for at least the WTRU-dedicated reception on the PDSCH and/or for all or a subset of CORESETs in a component carrier (CC). In an example, a WTRU may receive (for example, from a gNB) an indication of a second unified TCI to be used and/or applied for one or both of a PUCCH and a PUSCH (for example, and an uplink RS, as well). One or more source reference signal(s) in a second unified TCI may provide a reference for determining common uplink transmission (UL TX) spatial filter(s) at least for dynamic-grant and/or configured-grant based PUSCH and one, a subset of, or all of the dedicated PUCCH resources in a CC.

A WTRU may be configured with a first mode for one or more unified TCIs (for example, SeparateDLULTCI mode) where an indicated first unified TCI may be applicable for one or more downlink and an indicated second unified TCI may be applicable for one or more uplink. For example, the WTRU may be configured with a first mode for one or more unified TCIs where an indicated first unified TCI may be applicable for a downlink (for example, downlink only) and an indicated second unified TCI may be applicable for an uplink (for example, uplink only).

A WTRU may be configured with one or more of a second mode for one or more unified TCIs (for example, JointTCI mode) where an indicated unified TCI (for example, a third unified TCI) may be applicable for one or both of downlink and/or uplink (for example, based on the third unified TCI). In an example, the WTRU may be configured with a second mode for one or more unified TCIs (for example, JointTCI mode) where an indicated unified TCI (for example, a third unified TCI) may be applicable for one or both of downlink and/or uplink (for example, based on the third unified TCI).

In an example, the WTRU may receive (for example, from a gNB) an indication of the third unified TCI to be used and/or applied commonly for a PDCCH, a PDSCH, a PUCCH, a PUSCH, a downlink reference signal (DL RS), and/or an uplink reference signal (UL RS), based on the second mode (for example, JointTCI mode).

Herein, unified TCI may be interchangeably used with one or more of unified TCI-state, TCI, and/or TCI-state, while remaining consistent with an embodiment. Herein, a transmission and reception point (TRP) may be interchangeably used with one or more of transmission point (TP), reception point (RP), radio remote head (RRH), distributed antenna (DA), base station (BS), a sector (for example, a sector of a of a BS), and a cell (for example, a geographical cell area served by a BS), while remaining consistent with an embodiment. Herein, Multi-TRP may be interchangeably used with one or more of MTRP, M-TRP, and/or multiple TRPs, while remaining consistent with an embodiment.

The WTRU may be configured with, and/or may receive configuration of, one or more TRPs to which the WTRU may transmit and/or from which the WTRU may receive. The WTRU may be configured with one or more TRPs for one or more cells. A cell may be a serving cell and/or a secondary cell.

The WTRU may be configured with at least one RS for the purpose of channel measurement. A RS may be a Channel Measurement Resource (CMR). A RS may comprise one or more CSI-RS, SSB, and/or any downlink RS. A downlink RS may be transmitted from a TRP to the WTRU. A CMR may be configured and/or associated with one or more TCI states. The WTRU may be configured with one or more CMR groups where one or more CMRs transmitted from the same TRP may be configured. Each group may be identified by a CMR group index (for example, group 1). The WTRU may be configured with one CMR group per TRP. The WTRU may receive one or more linkages between one or more CMR group indexes and one or more other CMR group indexes, and/or between one or more RS indexes from one or more CMR groups and one or more other RS indexes from one or more other CMR groups.

The WTRU may be configured with, and/or receive configuration of, one or more pathloss (PL) reference groups (for example, sets) and/or one or more SRS groups, one or more SRS resource indicators (SRIs) and/or one or more SRS resource sets.

A PL reference group may correspond to and/or may be associated with one or more TRPs. A PL reference group may include, identify, correspond to and/or be associated with one or more of: TCI states, SRIs, reference signal sets (for example, CSI-RS set, SRI sets), Control Resource Set (CORESET) indexes, and/or reference signals (for example, CSI-RS, SSB, and/or the like).

The WTRU may receive one or more configurations (for example, any one or more of the configurations described herein). Each of the configurations may be received from a gNB and/or TRP. For example, the WTRU may receive one or more configurations of one or more TRPs, one or more PL reference groups and/or one or more SRI sets. The WTRU may implicitly determine an association between a RS set/group and a TRP. For example, if the WTRU is configured with two SRS resource sets, then the WTRU may determine to transmit to TRP1 with SRS in the first resource set, and to transmit to TRP2 with SRS in the second resource set. In an example, the configuration may be obtained through RRC signaling.

In the examples and embodiments described herein, “TRP,” “PL reference group,” “SRI group,” and/or “SRI set” may be used interchangeably. The terms “set” and “group” may be used interchangeably herein. The WTRU may report a subset of channel state information (CSI) components, where CSI components may correspond to at least one or more CSI-RS resource indicators (CRI), one or more SSB resource indicators (SSBRI), one or more indications of one or more panels used for reception at the WTRU (for example, one or more panel identities and/or group identities), one or more measurements such as L1-RSRP, L1-SINR taken from SSB and/or CSI-RS (for example, cri-RSRP, cri-SINR, ssb-Index-RSRP, ssb-Index-SINR), and/or any channel state information. For example, channel state information may comprise at least one or more of a rank indicator (RI), channel quality indicator (CQI), precoding matrix indicator (PMI), Layer Index (LI), and/or the like.

A unified TCI (for example, a joint or a pair of separate DL/UL) may be indicated and/or maintained at the WTRU. A unified TCI may be applicable for either one of or both of control and/or data channels simultaneously. An individual beam control per channel may exhibit different or the same characteristics.

A Multi-DCI based multi-TRP (MTRP) (MDCI-MTRP) may be based on CORESETPoolIndex=0 or 1, to support eMBB. A Single-DCI based MTRP (SDCI-MTRP) may be based on associating up to two TCI-states for a codepoint of TCI field in a DCI, for example, for repeated transmissions across TRPs and/or for reliability enhancements.

One or more unified TCIs (for example, a unified TCI to be mapped to each TRP) may be associated and/or updated. For example, the WTRU may detect one or more indications (for example, indications delivering one or more updates of unified TCIs) from one or more TRPs. An WTRU may identify one or more TRPs for which to apply. One or more MTRP-unified-TCIs may be updated across multiple Component Carriers (CCs)/Bandwidth Parts (BWPs) simultaneously, which may, for example, save signaling overhead. The reliability and/or latency for BFR may be improved for MTRP with unified TCIs.

A property of a grant and/or assignment may comprise one or more of: a frequency allocation; an aspect of time allocation (for example, a duration); a priority; a modulation and/or coding scheme; a transport block size; a number of spatial layers; a number of transport blocks; a TCI state, CRI and/or SRI; a number of repetitions; whether the repetition scheme is Type A or Type B; whether the grant is a configured grant type 1, type 2 or a dynamic grant; whether the assignment is a dynamic assignment or a semi-persistent scheduling (for example, configured) assignment; a configured grant index and/or a semi-persistent assignment index; a periodicity of a configured grant and/or assignment; a channel access priority class (CAPC); any parameter provided in a DCI, by MAC and/or by RRC for the scheduling the grant and/or assignment.

An indication by DCI may comprise one or more of: an explicit indication by a DCI field and/or by Radio Network Temporary Identifier (RNTI) used to mask cyclic redundancy check (CRC) of the PDCCH; and/or an implicit indication by a property. For example, an implicit indication by a property may comprise at least one or more of: DCI format, DCI size, CORESET or search space, aggregation Level, first resource element of the received DCI (for example, index of first Control Channel Element (CCE)). A mapping between a property and a value may be signaled by RRC and/or MAC.

A unified TCI pool may refer to one or more sets of unified TCIs (for example, a set of candidate unified TCIs) configured to one or more WTRUs. The sets of unified TCIs may be configured by RRC. One or more unified TCIs of the unified TCI pool may be indicated to the WTRU to be applied for multiple downlink and/or uplink channels (for example, for multiple control and data channels).

One or more TRP1 pools may be separate from one or more TRP2 pools. For example, each unified TCI pool for each TRP may be (for example, separately or independently) configured by RRC. For example, each unified TCI pool for (for example, based on and/or associated with) each WTRU-panel may be configured by RRC. For example, each unified TCI pool for each TRP may be associated with a CORESETPoolIndex value (for example, 0, 1, 2, 3, and so on). For example, a CORESETPoolIndex value may range from zero (0) to the number of TRPs that the WTRU communicates with. For example, a CORESETPoolIndex value may comprise one or more of a: TRP index, TRP indicator, TRP identification-related parameter, CORESET group index, and/or the like. In an example, Pool1 may be associated with CORESETPoolIndex=0 for TRP1. In an example, Pool2 may be associated with CORESETPoolIndex=1 for TRP2. The WTRU may be configured with an independent Unified-TCI-mode (for example, of either JointTCI or SeparateDLULTCI) for Pool1 and Pool2. In an example, Pool1 may be configured with the JointTCI mode. In an example, Pool2 may be configured with the SeparateDLULTCI mode. In an example, Pool1 may be configured with the JointTCI mode. In an example, Pool2 for DL (for example, comprising candidate DL unified TCIs) and Pool3 for UL (for example, comprising candidate UL unified TCIs) may be configured with a SeparateDLULTCI mode. In an example, WTRU may be configured with one or more of TCI states (for example, unified TCI states). For example, each TCI state may be comprised based on an aggregated form of one or more separate pools (for example, a separate pool for each TRP). In an example, a portion (for example, a part, or first one or more TCI-states) of a plurality of TCI-states (for example, the aggregated form) may be associated with one or more TRP (for example, the TRP1), where TCI-state IDs for the first one or more TCI-states in the portion or part may be assigned in an increasing order from a reference TCI-state ID. For example, the reference TCI-state IDs may be 0 for TRP1, X(>0) for TRP2, Y(>X) for TRP3, and so on.

TRP1 may have a common and/or shared pool with TRP2. The WTRU may be configured with one or more common and/or shared unified TCI pools for multiple TRPs. For example, the WTRU may determine and/or identify that a first unified TCI of the common unified TCI pool may be used and/or indicated for communications with TRP1. For example, the WTRU may determine and/or identify that a second unified TCI of the common unified TCI pool may be used and/or indicated for communications with TRP2. For example, the WTRU may make the determination and/or identifications of the unified TCIs based on one or more predefined rules and/or behaviors. For example, the WTRU may make the determination and/or identifications of the unified TCIs based on an explicit indication from a gNB (for example, TCI-state wise, per unified TCI within the common unified TCI pool). For example, the WTRU may make the determination and/or identifications of the unified TCIs based on associating a CORESETPoolIndex (for example, TRP index, TRP indicator, TRP identification-related parameter, CORESET group index, and/or the like) value per TCI-state and/or per unified TCI. For example, each TCI-state and/or unified TCI within a common pool may be associated with a CORESETPoolIndex value. For example, one TCI-state may be associated with CORESETPoolIndex=0 within the common pool for TRP1. For example, one TCI-state may be associated with CORESETPoolIndex=1 within the common pool for TRP2.

In an example, the WTRU may make one or more determinations and/or identifications of the unified TCIs based on a source RS, which may correspond to one or more TRPs, of a unified TCI. For example, the WTRU may make one or more determinations and/or identifications of the unified TCIs based on an indirect QCL rule. In response to determining that the source RS corresponds to, is associated with, and/or is transmitted from, a first TRP, the WTRU may determine and/or identify that the unified TCI is used for (for example, for communications with) a first TRP. In response to determining that the source RS corresponds to, is associated with, and/or is transmitted from, a second TRP, the WTRU may determine and/or identify that the unified TCI is used for (for example, for communications with) a second TRP.

In an example, a source RS may be a first CSI-RS for tracking, for example, a tracking reference signal (TRS). The first TRS may be configured with its source RS as a non-serving-cell RS, for example, a non-serving-cell SSB with a different physical cell-ID from the first TRS. In response to determining that a first TRS comprising its source RS is a non-serving-cell RS (for example, an SSB), the WTRU may identify and/or determine that a unified TCI (for example, comprising the source RS) may be used for inter-cell beam management and/or inter-cell TRP operation. For example, the unified TCI may be used for communications with inter-cell TRP. A source RS may be a second CSI-RS for tracking (for example, a TRS). A second TRS may have an association and/or relation to one or more CORESETPoolIndex values, which may comprise, for example, one or more of, a TRP index, a TRP indicator, a TRP identification-related parameter, a CORESET group index, and/or the like. In an example, in response to determining that a second TRS is associated with the CORESETPoolIndex value, the WTRU may identify and/or determine that a unified TCI (for example comprising a source RS) may be used for a TRP associated with the CORESETPoolIndex value.

A common unified TCI pool for both TRPs may be configured by RRC. In an example, the WTRU may be configured with a common and/or single Unified-TCI-mode for both TRP1 and TRP2, for example, applicable for the common unified TCI pool. For example, the common and/or single Unified-TCI-mode may be of either JointTCI or SeparateDLULTCI. The WTRU may perform a symmetrical behavior in communications with TRP1 and TRP2, which may result in a reduced complexity in WTRU implementation.

In an example, the WTRU may be configured with an independent Unified-TCI-mode for each TCI-state (for example, for each unified TCI) within the common pool. For example, the independent Unified-TCI-mode may be of either JointTCI or SeparateDLULTCI. The configuration with an independent Unified-TCI-mode for each TCI-state (for example, within the common pool) may result in more flexible and efficient operations for each TRP. For example, each TRP may utilize an independent unified TCI mode, for example, in exchange for increased WTRU complexity. The independent unified TCI mode may be, for example, either JointTCI or SeparateDLULTCI.

In an example, the WTRU may be configured with the same unified-TCI-mode across different TCI-states (for example, different unified TCIs), which are all mapped to a TRP, which may be the same TRP. In an example, if a first unified TCI that is mapped to a first TRP (for example, via a CORESETPoolIndex=0, etc.) is associated with a first Unified-TCI-mode (which may be, for example, either JointTCI or SeparateDLULTCI), the WTRU may identify and/or determine that a second unified TCI that is mapped to the same first TRP (which may be the same TRP) is to be associated with the first Unified-TCI-mode (which may be the same Unified-TCI-mode).

In an embodiment, unified TCI activations (for example, using MAC-CE) for M-TRPs may have separate MAC-CE activations for TRP1 and/or TRP2. The WTRU may receive an indication (for example, via MAC-CE) comprising a TRP-indicator that activates one or more TCI-states (for example, unified TCI-states) of a plurality of TCI-states (for example, unified TCI-states) configured for a TRP associated with the TRP-indicator. The TRP-indicator may be a parameter of and/or associated with a CORESETPoolIndex. For example, the WTRU's activation of one or more TCI-states may be associated with the WTRU's mapping of the one or more TCI-states to one or more codepoints of a TCI field in a DCI (for example, for an element and/or entry based on a one-to-one mapping).

In an example, the WTRU may receive an indication (for example, via MAC-CE), comprising one or more TRP-indicators, that activates a first one or more TCI-states (for example, unified TCI-states) of a first plurality of TCI-states (for example, unified TCI-states) configured for TRP1 associated with the first TRP-indicator of the one or more TRP-indicators. The first plurality of TCI-states may be, for example, Pool1. The WTRU may receive an indication (for example, via MAC-CE), comprising one or more TRP-indicators, that activates a second one or more TCI-states (for example, unified TCI-states) of a second plurality of TCI-states (for example, unified TCI-states) configured for TRP2 associated with the second TRP-indicator of the one or more indicators. The indication that comprises the one or more TRP-indicators may comprise an aggregated structure of signaling the indication. For example, the aggregated structure may imply one or more individual TCI-activation formats per TRP and/or associated with each TRP-indicator in the same MAC-CE indication message.

In an embodiment, unified TCI activations (for example, using MAC-CE) for M-TRPs may be associated with TRP1 and TRP2 having a Common MAC-CE activation. The WTRU may receive an indication (for example, through a MAC-CE), comprising a parameter for monitoring DCIs, that activates one or more TCI-states (for example, unified TCI-states) of a plurality of TCI-states (for example, unified TCI-states). In an example, the activation of one or more TCI-states may indicate that the WTRU may map the one or more TCI-states to one or more codepoints of TCI field in a DCI (for example, for an element and/or entry, based on a one-to-one mapping) based on the parameter for monitoring DCIs.

In an example, in response to determining that the parameter for monitoring DCIs indicates a first one (for example, a first value), the WTRU may map the one or more TCI-states to one or more codepoints of TCI field for a DCI, where the WTRU may receive the DCI based on a first one or more CORESETs. For example, the first one or more CORESETs may be associated with a first TRP, associated with a first group of CORESETs, associated with a first TRP-indicator, associated with a first CORESETPoolIndex value, and/or the like).

In an example, in response to determining that the parameter for monitoring DCIs indicates a second one (for example, a second value), the WTRU may map the one or more TCI-states to one or more codepoints of TCI field for a DCI, where the WTRU may receive the DCI based on second one or more CORESETs. For example, the second one or more CORESETs may be associated with a second group of CORESETs, associated with a second TRP-indicator, associated with a second CORESETPoolIndex value, and/or the like.

The parameter for monitoring DCIs may indicate that contents of the indication (for example, through MAC-CE) for activating the one or more TCI-states (for example, unified TCI-states) may be valid (for example, mapped and/or used) for the one or more codepoints of a DCI, when the DCI is received via a set of CORESETs of a plurality of CORESETs (for example, being configured to the WTRU). For example, the set of CORESETs may be one or more CORESETs associated with a TRP (for example, a TRP-indicator and/or a CORESETPoolIndex value).

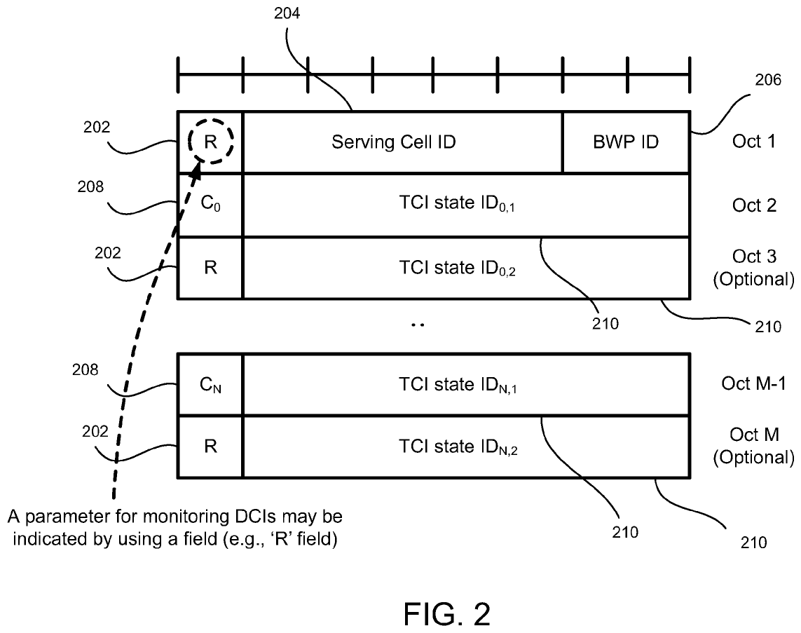

FIG. 2 is a diagram illustrating an example of parameters for monitoring DCIs. In an embodiment, the parameter for monitoring DCIs may be indicated via a reserved field (R field) 202 in a MAC-CE message for activating TCI-states. A parameter for monitoring DCIs may be indicated by replacing a field indicating a CORESETPoolIndex value in a MAC-CE message for activating TCI-states (for example, for one or more multi-TRP operations and/or features). A Serving Cell ID field 204 may indicate an identity (ID) of a Serving Cell (for example, a component carrier (CC), as serving-cell, and/or a cell) for which the indication (for example, MAC CE) applies. The length of the Serving Cell ID field may be 5 bits. If the indicated Serving Cell is configured as part of a CC list for simultaneous TCI updates (for example, simultaneousTCI-UpdateList1, simultaneousTCI-UpdateList2, and so on), the indication (for example, this MAC CE) may apply to all the Serving Cells configured in the CC list (for example, the set simultaneousTCI-UpdateList1, or simultaneousTCI-UpdateList2, respectively).

A BWP ID field 206 may indicate a DL BWP for which the indication (for example, the MAC CE) applies as the codepoint of a bandwidth part indicator field of a DCI. The length of the BWP ID field 204 may be, for example, 2 bits. A CN field 208 may indicate whether or not the octet (Oct) containing TCI state ID_{N,2} is present. In an example, if this field is set to 1, the octet containing TCI state ID_{N,2} is present, which may indicate that two unified TCIs (for example, one for TRP1 and another for TRP2) may be simultaneously indicated by a DCI based on a codepoint (e.g., being associated with the index N, for example, TCI state ID_{N,1} and TCI state ID_{N,2}) of a TCI field of the DCI. In an example, if this field is set to “0”, the octet containing TCI state ID_{N,2} may not be present, indicating that one unified TCI (for example, for TRP1 as a primary and/or default TRP) may be indicated by a DCI based on a second codepoint (being associated with the index N, for example, TCI state ID_{N,1}) of a TCI field of the DCI. A TCI state ID_{N,M} field 210 may indicate a TCI-state (for example, a unified TCI-state) identified by a TCI-state ID (for example, TCI-StateId), where N may be an index of a codepoint of a TCI (Transmission configuration indication) field of a DCI. The TCI state ID_{N,M} may denote, imply, and/or corresponds to the M-th TCI-state indicated for the N-th codepoint in the TCI field of the DCI. One or more codepoints of the TCI field, to which the TCI-states (for example, corresponding to the TCI state ID_{N,M}) are mapped, may be determined by its ordinal position among one or more TCI codepoints with sets of TCI state ID_{N,M} fields 210 (e.g., in the MAC CE message). The TCI-states may be unified TCI-states.

In an example, as shown in FIG. 2, a first TCI codepoint with a TCI state ID_{0,1} and/or a TCI state ID_{0,2} (for example in a MAC CE message) may be mapped to a codepoint value 0 of the TCI field. A second TCI codepoint with a TCI state ID_{1,1} and/or a TCI state ID_{1,2} may be mapped to a codepoint value 1 of the TCI field, and so on. The TCI state ID_{N,2} may be optional, and/or may be based on the indication of the Cᵢ field. The maximum number of an activated TCI codepoint (for example in the MAC CE message) may be 8. The maximum number of TCI states mapped to a TCI codepoint (for example a single TCI codepoint) may be 2. The TCI codepoint may be of a MAC CE message. As an example, the 2 TCI states that are mapped to the TCI codepoint may be TCI state ID_{N,1} and/or TCI state ID_{N,2}. An R field 202 may indicate and/or be set to a reserved bit. For example, the R field 202 may be set to 0. A first R field 202 (for example in October 1 of FIG. 2) may be for a field indicating, for example, a parameter for monitoring DCIs.

In an example, shown in FIG. 2, the reserved R-field 202 in October 1 may be enhanced (for example, used, replaced, and/or changed) as a new field indicating the parameter for monitoring DCIs, which may indicate one or more TCI pool(s) (for example, Pool1, or Pool2, and so on). The TCI pool(s) may be unified TCI pool(s). The new field indicating the parameter for monitoring DCIs may be associated with one or more CORESETPoolIndex parameters, for example, one or more: TRP indexs, TRP indicators, TRP identification-related parameters, CORESET group indexs, and/or the like. A value of the parameter for monitoring DCIs indicated by the MAC CE may indicate and/or select one or more TCI pool(s) (for example, Pool1, or Pool2, and so on). The TCI pool(s) may be unified TCI pool(s). The activated and/or indicated TCI(s) (e.g., which may be indicated by one or more TCI state ID_{i,j} field(s)) in this MAC CE may be selected and/or activated within the indicated TCI pool, which may be a unified TCI pool. As an example, the indicated TCI pool, which may be a unified TCI pool, may be configured and/or associated with a TRP, for example, TRP1 and/or TRP2, and the like.

If the indicated value of the new field indicating the parameter for monitoring DCIs is 0, the WTRU may determine that this MAC CE message activates one or more TCI-states (e.g., which may, for example, be unified TCI states) of a first (for example, a default and/or primary) TRP's pool(s) (for example, Pool1, and/or Pool1D for DL and Pool1U for UL, and the like). For example, WTRU may be configured with two or more separated unified TCI pools (for example, Pool1D for DL and Pool1U for UL) for a TRP. In an example, Pool1D comprise one or more DL TCI-states (for example, DL unified TCI-states) for a DL beam indication. Pool1U may be comprised with one or more UL TCI-states (for example, UL unified TCI-states) for a UL beam indication. In an example, a TCI-state of the one or more UL TCI-states (for example, UL unified TCI-states) may be further associated with one or more UL-related parameter(s). For example, the one or more UL-related parameter(s) may be power control (PC) parameter(s), and/or a timing control parameter(s) (for example, timing advance (TA), and the like.

In an example, if the new field indicating the parameter for monitoring DCIs is set to 0 and the C_{N} field in the same MAC CE is set to 0, the WTRU may determine that the octet containing TCI state ID_{N,2} is not present and the one unified TCI (which may, for example, be based on TCI state ID_{N,1}) is used for TRP1 (for example, used as a primary and/or default TRP) based on determining that the new field indicating the parameter for monitoring DCIs is set to 0. Beam indication flexibility and efficiency may be increased. For example, a single unified TCI (which may, for example, be based on TCI state ID_{N,1}) being associated with a codepoint of a TCI field of a DCI may be flexibly selected (for example, by the MAC CE) from which one or more unified TCI pools (for example, Pool1 for TRP1 and/or Pool2 for TRP2, and the like), and may or may not be fixed to a primary and/or default TRP (for example, TRP1). The increased beam indication flexibility and efficiency may be provided based on, for example, the new field indicating the parameter for monitoring DCIs (for example, the parameters may be set to 0 or 1) in the MAC CE.

If the indicated value of the new field indicating the parameter for monitoring DCIs is 1, the WTRU may determine that this MAC CE message activates a second one or more TCI-states (which may be, for example, unified TCI-states) of a second (for example, secondary) TRP's pool(s) (for example, Pool2, or Pool2D for DL and Pool2U for UL, and the like). For example, the WTRU may be configured with two or more separated unified TCI pools (for example, Pool2D for DL and Pool2U for UL, and the like) for a TRP. Pool2D may be comprised of one or more DL TCI-states (which may be, for example, unified TCI-states) for a DL beam indication. Pool2U may be comprised with one or more UL TCI-states (which may be, for example, unified TCI-states) for a UL beam indication. In an example, a TCI-state of the one or more UL TCI-states (which may be, for example, unified TCI-states) may be further associated with one or more UL-related parameter(s). The UL-related parameter(s) may be, for example, power control (PC) parameter(s), and/or a timing control (for example, timing advance (TA)) parameter(s), and/or the like).

In an example, if the new field indicating the parameter for monitoring DCIs is set to 1 and the Cᵢ field in the same MAC CE is set to 0, the WTRU may determine that the octet containing TCI state ID_{N,2} is not present. The one unified TCI (which may, for example, be based on TCI state ID_{N,1}) may be used for TRP2 (which may, for example, serve as a secondary TRP) based on determining that the new field indicating the parameter for monitoring DCIs is set to 1. Beam indication flexibility and efficiency may be increased. For example, a single unified TCI (which may, for example, be based on TCI state ID_{N,1}) being associated with a codepoint of a TCI field of a DCI may be flexibly selected (for example, selected by the MAC CE) from which one or more unified TCI pool(s) (for example, Pool1 for TRP1, and/or Pool2 for TRP2, and the like), and may or may not be fixed to a primary and/or default TRP (for example, TRP1). The increased beam indication flexibility and efficiency may be provided based on, for example, the new field indicating the parameter for monitoring DCIs (for example, the parameters may be set to 0 or 1) in the MAC CE.

In an example, separate one or more DCI indications for each of the one or more TRPs (for example, TRP1 and TRP2) may achieve unified TCI indications (for example, via DCI) for M-TRP. In an example, separate one or more DCI indications may be for multi-DCI (MDCI) based MTRP. For example, DCI1 being received via first one or more CORESETs (for example, CORESET group 1) may indicate a unified TCI for TRP1 (for example, a TRP associated with the first one or more CORESETs). DCI2 being received via second one or more CORESETs (for example, CORESET group2) may indicate a unified TCI for TRP2 (for example, a TRP associated with the second one or more CORESETs). For example, DCI for indicating unified TCI(s), for example, the DCI1 and/or the DCI2, may comprise a DL-related DCI (for example, DCI format 1_1 and/or DCI format 1_2, and the like). In an example, the DCI may comprise a DL assignment (for example, a DL data and/or PDSCH scheduling grant). In an example, the DCI may not comprise the DL assignment, for example, where the DCI may be applicable with or without DL assignment.

In an embodiment, one or more common and/or single DCI indications for both TRP1 and TRP2 may achieve unified TCI indications (for example, via DCI) for M-TRP. One or more common and/or single DCI indications may be for single-DCI (SDCI) based MTRP. For example, a DCI for indicating unified TCI(s) (for example, with or without a DL assignment) may comprise an explicit indicator (for example, a TRP indicator) which indicates whether the contents of the DCI is for, and/or corresponds to, TRP1. The explicit indicator (for example, a TRP indicator) which indicates whether the contents of the DCI is for, and/or corresponds to, TRP2. In an example, a DCI for indicating unified TCI(s) (e.g., with or without DL assignment) may comprise at least two parts of information contents, where a first part of the at least two parts may comprise one or more first unified TCI(s) corresponding to TRP1, and a second part of the at least two parts may comprise one or more second unified TCI(s) corresponding to TRP2. In an example, both parts may be in a single DCI. For example, the WTRU may receive a DCI for indicating unified TCI(s) (for example, with or without DL assignment). In response to the receiving, the WTRU may determine, based on which CORESET being used for delivering the DCI, that the DCI is for and/or corresponds to either TRP1 or TRP2. In an example, in response to determining that the DCI is received at the WTRU via a first CORESET (for example, first CORESET group), the WTRU may determine that contents of the DCI is for and/or corresponds to TRP1. In response to determining that the DCI is received at the WTRU via a second CORESET (for example, second CORESET group), the WTRU may determine that contents of the DCI is for and/or corresponds to TRP2.

One or more of the following example instances may apply when applying indicated unified TCI(s) (e.g. via a DCI) to one or more physical channel(s) and/or signal(s) (e.g. including at least CORESET(s). In an example instance, the WTRU may be configured with a plurality of unified TCIs (e.g. UTCIs), (e.g., as a unified TCI pool). In an example instance, the WTRU may be configured/indicated with an information content associating a first UTCI (e.g. UTCI1), of the plurality of UTCIs, with a first list of one or more physical channel(s) and/or signal(s) which the UTCI1 is applied to, for example, when the UTCI1 is indicated by a DCI. The WTRU may be configured/indicated with an information content associating a second UTCI (e.g. UTCI2), of the plurality of UTCIs, with a second list of one or more physical channel(s) and/or signal(s) which the UTCI2 may be applied to, when the UTCI2 may be indicated by a DCI. In an example, the WTRU may be configured/indicated with an information content associating a third UTCI (e.g. UTCI3), of the plurality of UTCIs, with a third list of one or more physical channel(s) and/or signal(s) which the UTCI3 may be applied to, when the UTCI3 may be indicated by a DCI. In an example, the WTRU may be configured/indicated with an information content associating a fourth UTCI (e.g. UTCI4), of the plurality of UTCIs, with a fourth list of one or more physical channel(s) and/or signal(s) which the UTCI4 may be applied to, when the UTCI4 may be indicated by a DCI. In an example, the WTRU may be configured/indicated with an information content associating a (e.g. first, second, third, fourth, and so on) UTCI (e.g. UTCI3), of the plurality of UTCIs, with a (e.g. first, second, third, fourth, and so on) list of one or more physical channel(s) and/or signal(s) which the UTCI3 may be applied to, when the UTCI3 may be indicated by a DCI. In an example instance, a list (e.g., the first list, the second list, the third list, the fourth list, and so on) of one or more physical channel(s) and/or signal(s) may comprise any one or a combination of one or more of the following: one or more CORESETs; one or more PDCCH candidates; one or more search spaces; one or more PDSCHs (e.g., PDSCH occasions/configurations/instances/and the like); one or more RSs (e.g., CSI-RSs, DMRSs, SSB indexes, PRSs, PTRSs, and/or SRSs); one or more PUSCHs (e.g., PUSCH occasions/configurations/instances/and the like); one or more PUCCH resources (e.g., PUCCH resource sets/groups/and the like); one or more PRACH occasions/resources/RSs/and the like.

In an example instance, a method may be applied (e.g. on how to apply indicated UTCI(s)). In a method for applying indicated UTCI(s), the WTRU may determine which CORESET(s) to apply, and the WTRU may (e.g. then) apply the indicated UTCI(s) to the determined CORESET(s). For example, the WTRU may determine which CORESET(s) to apply based on one or more of the following: based on determining a CORESET via which a DCI indicating the UTCI(s) is transmitted, the WTRU may apply the indicated UTCI(s) to CORESET(s) (which may include at least the determined CORESET); based on determining a first CORESET via which a DCI indicating the UTCI(s) is transmitted, the WTRU may determine a second CORESET (which is different from the first CORESET and paired with the first CORESET) based on a pre-defined or pre-configured parameter/information, e.g., TRP1 associated with at least the first CORESET and TRP2 associated with at least the second CORESET. The WTRU may apply the indicated UTCI(s) to CORESET(s) based on determining a CORESET through which a DCI may indicate the UTCI(s) may be transmitted. In an example, the WTRU may receive the DCI which may indicate UTCI1, where the DCI may be transmitted via CORESET1 (e.g., corresponding to TRP1). In response to receiving the DCI and determining the DCI is transmitted via the CORESET1, the WTRU may apply the indicated UTCI1 to the determined CORESET1 (e.g., after a beam application time (BAT) timing). In an example, the WTRU may receive the DCI which may indicate UTCI1 and UTCI2, where the DCI may be transmitted via CORESET1 (e.g., corresponding to TRP1). In response to receiving the DCI and determining that the DCI is transmitted via the CORESET1, the WTRU may further determine that there are pre-defined and/or pre-configured TRP-pair information (e.g., CORESET-pair information, CORESET-grouping information, and the like), for example, CORESET1 and CORESET2 may be paired when two UTCIs are indicated together in a single DCI. For example, based on the TRP-pair information (e.g., a pair of {CORESET1, CORESET2}, etc.), the WTRU may determine that the indicated UTCI2 may be applied to CORESET2, and the WTRU may apply the indicated UTCI1 to the CORESET1 and the indicated UTCI2 to the CORESET2. In an example, a (e.g., individual) TRP may control its own UTCI beam update by signaling the DCI using at least one CORESET associated with the TRP, which may, for example, improve UTCI update efficiency and/or flexibility, and/or may reduce complexity on the UTCI update as the TRP may directly update a UTCI for at least one CORESET associated with the TRP.

At a given time, one CORESET beam in a TRP may be updated with a UTCI indicated by a DCI transmitted from the TRP. In an example, the WTRU may determine a second CORESET (which may be different from the first CORESET and may be paired with the first CORESET) based on determining a first CORESET via which a DCI indicating the UTCI(s) is transmitted. In an example, in conjunction or alternatively, the WTRU may determine a second CORESET the based on a pre-defined or pre-configured parameter/information, e.g., TRP1 associated with at least the first CORESET and TRP2 associated with at least the second CORESET. In an example, the WTRU may apply the indicated UTCI(s) to CORESET(s) (e.g. including at least the second CORESET). In an example, the WTRU may receive the DCI which may indicate UTCI1, where the DCI may be transmitted via CORESET1 (e.g., corresponding to TRP1). In response to receiving the DCI and determining that the DCI may be transmitted via the CORESET1, the WTRU may further determine that CORESET2 may be associated with the CORESET1, based on the pre-defined and/or pre-configured parameter/information. In an example, the WTRU may apply the indicated UTCI1 to the determined CORESET2 (e.g., after a BAT timing).

The WTRU may receive the DCI which indicates UTCI1 and UTCI2, where the DCI is transmitted via CORESET1 (e.g., corresponding to TRP1). In response to receiving the DCI and determining the DCI is transmitted via the CORESET1, the WTRU may determine that CORESET2 is associated with the CORESET1, for example, based on the pre-defined or pre-configured parameter/information, and that there are pre-defined or pre-configure TRP-pair information (e.g., CORESET-pair information, CORESET-grouping information, etc.), e.g., CORESET2 and CORESET3 are paired when two UTCIs are indicated together in a single DCI. The WTRU may determine that the indicated UTCI2 may be applied to CORESET3, for example, based on the TRP-pair information (e.g., a pair of {CORESET2, CORESET3}, and the like). The WTRU may apply the indicated UTCI1 to CORESET2 and the indicated UTCI2 to the CORESET3, for example, based on the TRP-pair information (e.g., a pair of {CORESET2, CORESET3}, and the like). In an example, a UTCI indicated by a DCI delivered via a CORESET (e.g., corresponding to TRP1) may be applied to a second CORESET (e.g., corresponding to a TRP other than the TRP1), which may improve a reliability on CORESET beam update by avoiding a self-beam update error case, e.g., when the DCI may be erroneously received at the WTRU.

A method for applying indicated UTCI(s) may be carried out. For example, based on the information content associated with an indicated UTCI (of the indicated UTCIs), the WTRU may determine which CORESET(s) is/are associated with the indicated UTCI, and the WTRU may (e.g. then) apply the indicated UTCI to the determined CORESET(s). The WTRU may receive a DCI indicating UTCI1 and UTCI2 (e.g., indicated by a TCI codepoint of the DCI). The WTRU may receive a DCI indicating a TCI value (e.g, wherein the TCI value may be indicated in a TCI field). The WTRU may determine that a first set of CORESET(s) may be associated with UTCI1, for example, based on a first information content associated with UTCI1. The WTRU may determine that a second set of CORESET(s) may be associated with UTCI2, for example, based on a second information content associated with UTCI2. In response to determining that the first set of CORESET(s) is associated with UTCI1 and second set of CORESET(s) may be associated with UTCI2, the WTRU may apply the indicated UTCI1 to the first set of CORESET(s) and the indicated UTCI2 to the second set of CORESET(s). In an example, a UTCI indicated by a DCI may be applied to (e.g. at least to one or more) CORESETs, (e.g. simultaneously) which may be pre-associated with the UTCI. For example, the WTRU may determine (e.g., based on information the WTRU received) that a first CORESET is associated with a first TCI state instance and that a second CORESET is associated with a second TCI state instance.

In example UL aspects that may be based on unified TCIs for MTRPs, one or more UL TCI may be updated for one or more partial and/or complete set of TRPs. The WTRU may determine a UL-TCI and may apply it for transmissions to a subset of TRPs. For example, the WTRU may be associated with more than one (for example, N) TRPs. The WTRU may receive an UL TCI indication that applies only for transmission to a subset of n out of N TRPs. The WTRU may receive an UL TCI command with an indication of one or more TRPs. For example, the indication of one or more TRPs may be a source RS, and the WTRU may determine that any UL-TCI with the same source RS ID may apply the UL-TCI. For example, the WTRU may be configured with TRP1 and TRP2, and the WTRU may determine that UL-TCIs are partitioned into TRP groups through the source RS association (for example, the source RS index for a UL TCI may belong to a group of RSs configured into an RS group for TRP1 such as a Channel Measurement Resource (CMR) group). If the WTRU receives a grant for UL transmission to TRP1, the WTRU may determine to switch its spatial filters according to the UL TCI. If the WTRU receives a grant for UL transmission to TRP2, the WTRU may determine to use the spatial filters configured for TRP2. For example, the UL TCI may or may not apply for TRP2.

In an example, the WTRU may receive a unified UL TCI indication and an indication that the UL TCI may apply for all configured TRPs. For example, one UL TCI state may be configured with an additional flag. If the WTRU receives a UL TCI state with the flag turned on, the WTRU may determine to switch UL spatial filters for any subsequent UL transmission. For example, the WTRU may determine to switch UL spatial filters regardless of target TRP. If the WTRU receives a UL TCI state with the flag turned off, the UL TCI may apply for transmissions to the TRP associated with the UL TCI.

In an embodiment, one or more implicit UL TCI states may update for one or more second TRPs using a first UL TCI state, which may be based on unified TCIs for MTRPs. The WTRU may determine an association between one or more UL TCI states from different pools (for example, different TRPs), and/or UL TCI states within a pool (for example, both TRPs in same pool). For example, one or more pairings of UL TCI states may correspond to one or more pairings of TRPs. The one or more pairings may be through a bitmap in the TCI state configuration, and/or through an association between pairs of source RSs (for example, CSI-RS IDs from different CMR groups paired together). If the WTRU receives an UL TCI state indication for one index in the pair, the WTRU may determine to update its UL TCI state for the other index in the pair based on linked TCI states. For example, the WTRU may be configured with UL TCI1 and UL TCI2 for TRP1 and TRP2, respectively, and the UL TCIs may be associated together. If the WTRU receives an UL TCI indication with UL TCI1 for TRP1, then the WTRU may implicitly determine that the UL TCI for TRP2 is the one associated to UL TCI1, for example, UL TCI2.

A UL TCI may be provided for simultaneous UL transmission to multiple TRPs. In an example, the WTRU may receive a UL TCI with a TCI state associated with a transmission mode and/or hypothesis. For example, a transmission mode may be a simultaneous transmission, where the WTRU may transmit to two TRPs in the same time unit (for example, slot, symbol). For example, the WTRU may receive an UL TCI where one TCI codepoint may be configured with two TCI states associated to two different TRPs. The WTRU may determine that this codepoint may be used for simultaneous UL transmission. If the WTRU receives a grant with this codepoint, and the TCI states are associated to different panels, the WTRU may determine to adjust its spatial filters to simultaneously transmit on the same time resource using the different panels. If the TCI states are associated to the same panel, the WTRU may determine to adjust its spatial filters in a time division multiplexing (TDM) pattern. The TDM pattern may be preconfigured (for example, cyclical, sequential, and/or the like) and/or configurable. The TDM pattern may be configured in a TimeDomainResourceAllocation (TDRA) table such that a TDRA table index may indicate a mapping of UL TCI states to one or more scheduled grant resources. In an example, a UL TCI codepoint with two TCI states may be configured with an explicit flag to signal the associated transmission mode. The WTRU may determine whether to use TCI states simultaneously as a function of the flag. If the flag is on, the WTRU may determine that both TCI states may be used for simultaneous uplink transmission. If the flag is off, the WTRU may determine that both TCI states may be used for non-simultaneous transmission.

In an embodiment, power control parameters may be associated with UL TCI states. For example, the WTRU may determine a set of one or more power control parameters (for example, closed and open loop parameters such as pathlossReferenceRS-Id, TPC, P0, alpha, and/or the like) associated to one or more UL TCI states as a function of the UL TCI pool index. For example, when separate UL TCI pools are configured (for example, Pool 1 for TRP1 and Pool 2 for TRP2, and the like), the WTRU may determine to use one set of power control parameters for TRP 1 when receiving an indication to use an UL TCI from Pool 1, and may use a second set of power control parameters for TRP2 when receiving an indication to use an UL TCI from Pool 2.

In an example, if one or more UL TCIs for one or more TRPs are configured in a single pool, the WTRU may receive a configuration with two sets of power control parameters per UL TCI state. For example, each set of power control parameters may be associated with a TRP identifier (for example, such as through an RS index or CORESETpoolindex). For example, one UL TCI state may be configured with pathlossReferenceRS-Id1 and pathlossReferenceRS-Id2 as the pathloss reference for TRP1 and TRP2, respectively.

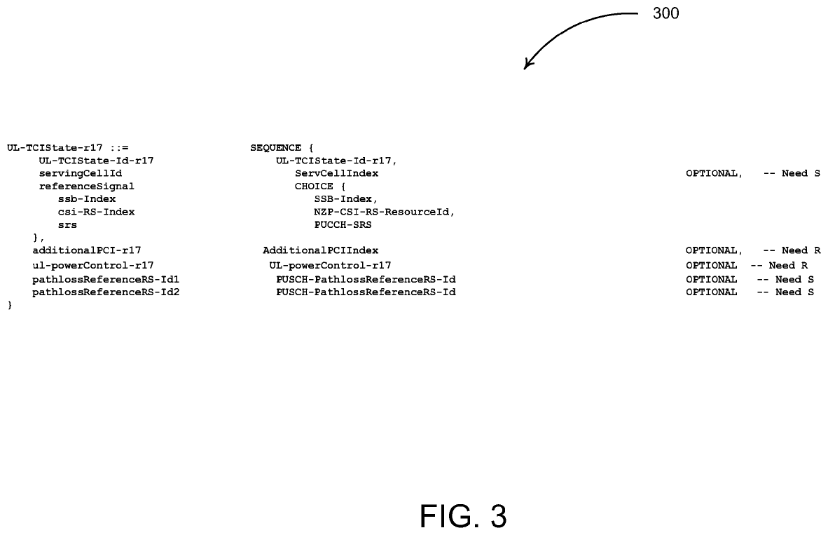

FIG. 3 illustrates an example process 300 for a UL-TCI. For example, the UL-TCI IE may be configured with two pathlossreferenceRS, as shown in FIG. 3. The set of power control parameters in the UL-TCI state may be semi-statically configured (for example, RRC), or dynamically indicated (for example, MAC-CE, DCI, and/or the like) per UL TCI pool or per UL TCI state. For example, the WTRU may receive an UL TCI state with two sets of power control parameters configured. The WTRU may receive a MAC-CE which indicates to activate the UL TCI state with the first set of power control parameters. The WTRU may receive a flag in the MAC-CE (for example, 0 or 1) which indicates whether to activate a first or a second set of power control parameters. The activating MAC-CE may include explicit fields for configuring the power control parameters. For example, the WTRU may activate an UL TCI with a P0 value indicated in the MAC-CE. The WTRU may determine its transmission power for the UL TCI state as a function of the set of power control parameters activated by the received flag.

In an embodiment, both power control sets may be activated in a single UL TCI state. The MAC-CE may contain one flag per set of power control parameters, and the flag may be activated for both sets. The WTRU may determine its transmission power for the UL TCI state as a function of both sets of activated power control parameters, and as a function of a received scheduling grant. For example, the WTRU may receive a scheduling grant indicating PUSCH repetition or multi-PUSCH transmission towards more than one TRP, and with an indication to use an UL TCI state with more than one set of activated power control parameters. In an example, the WTRU may adjust its UL spatial filter to the indicated UL TCI, and may use a first set of power control parameters when transmitting towards TRP1, and a second set of power control parameters when transmitting towards TRP2. The WTRU may determine the association between the power control parameters set and TRPs based on the mapping of PUSCH transmission to slot indices indicated in the DCI (for example, based on a time-domain resource assignment (TDRA) field). The PUSCH transmissions may be, for example, repetitions of a codeword, and/or different codewords (such as, for example, one or more multi-PUSCH transmissions).

In an embodiment, the WTRU may be configured in a SeparateDLULTCI where a first and second indicated unified TCI states (for example, a first and a second RS) may be used as the source RSs for downlink and uplink transmissions, respectively. In an example, the WTRU may be configured in a JointTCI mode where a same RS may be used as the source reference signal for both uplink and downlink transmissions.

For example, the WTRU equipped with multiple panels may be configured with more than one unified TCI configuration. For a multi-panel WTRU, different combinations of unified TCI configurations may be considered. In an example, the WTRU may be configured with more than one SeparateDLULTCI configuration, where each configuration may be applied to a different panel. In this configuration, for example, the WTRU may use a different RS source for UL and DL transmissions for each panel, respectively. In an example, the WTRU may be configured with a Semi-SeparateDLULTCI configuration, where the WTRU may use a first RS as the RS source for uplink transmission for all panels, and then use the remaining RSs as the source RSs for downlink transmissions for remaining panels (for example, a set of panels, first one or more panels, and/or the like.). In an example, the WTRU may be configured with a Semi-SeparateDLULTCI configuration, where the WTRU may use a first RS as the RS source for downlink transmission for all panels, and then may use the remaining RSs as the source RSs for uplink transmissions from remaining panels (for example, a set of panels, second one or more panels, and/or the like). In an example, the WTRU may be configured with more than one JointTCI configurations, where each configuration may be applied to a different panel. In the example configuration, the WTRU may use a same RS source for UL and/or DL transmissions from and/or to each panel. In a solution, the WTRU may be configured with at least one of each SeperateDLULTCI and JointTCI configurations where each configuration may be applied to at least one panel. In this configuration, the WTRU may use a same RS as the source RS for both uplink and downlink transmission for at least one panel, while for remaining panels, the WTRU may use different RS sources for UL and DL transmissions.

In an embodiment, a multi-panel WTRU may be configured semi-statically with a combination of above unified TCI configurations, from which the WTRU may dynamically determine a preferred mode of operation. In an example, the dynamic indication may be done by an explicit signaling, for example, MAC CE, a DCI, and the like. In an example, the dynamic indication may be done implicitly based on other system operational characteristics and/or features. In an example, the WTRU may determine an employed type of unified TCI configuration based on a mode of transmission, for example, single-TRP and/or multi-TRP, and/or the like. In an example, the WTRU may use one mode of unified TCI configuration per panel for single TRP transmission, and may use another mode for a multi-TRP transmission. In an example, the WTRU configured with secondary uplink (SUL) operation may use one type of unified TCI configuration for the primary link, and may use a simplified unified TCI (for example, UL TCI) for the SUL link. In an example, the WTRU may be configured with more than one unified TCI configuration, where the WTRU may determine the employed type of unified TCI configuration (for example, for a panel, and/or for all activated panels, and/or the like) based on the number of configured SRS ports, activated number of panels, antenna groups, etc.

In an example multi-TRP transmission scenario, the WTRU may determine the mode of unified TCI configuration for each panel. For example, the WTRU may determine the mode of unified TCI configuration based on one or more of the following embodiments. In an embodiment, the WTRU may determine the mode of unified TCI configuration based on the associated TRP to the panel. In an exemplary embodiment, the WTRU may use one mode of the operation, for example, SeparateDLULTCI for transmissions involved with the primary TRP, and another mode of operation, for example, JointTCI for the other TRP. For example, the WTRU equipped with only a single panel may apply a similar approach for determination of the unified TCI configuration. In an embodiment, the WTRU may determine the mode of unified TCI configuration based on a signal quality measurement (for example, RSRP, and the like). In an example, the WTRU may use JointTCI configuration if the measured RSRP is above a configured threshold. For example, the WTRU equipped with only a single panel may apply a similar approach for determination of the unified TCI configuration.

In an example, the WTRU may determine the mode of unified TCI configuration based on blockage or a proximity measure. For example, if a signal quality measurement is impaired due to a signal blockage, the WTRU may switch from one mode of unified TCI configuration to another mode. For example, if the WTRU is initially configured with a JointTCI configuration, it may switch to a configured SeparateDLULTCI configuration to have a more reliable transmission and reception. In a multi-panel WTRU, the WTRU may determine mode of unified TCI configuration based on blockage for each panel independently. Once the WTRU changed the mode of unified TCI configuration for panel, the corresponding mode of the other panel may change to a same or another preconfigured mode. In an example, the WTRU may receive a value as the validity period for the configured unified TCI configuration. For example, the WTRU may receive a first indication for starting the applicability of the unified TCI configuration, and a second indication for the termination of such applicability. Once the applicability period is expired, the WTRU may fall back to a default mode of TCI configuration (for example, where the default mode of TCI configuration may be pre-defined or pre-configured by a gNB, which may be a JointTCI mode, a SeparateDLULTCI mode, or a legacy TCI mode (for example, as an individual TCI indication mode)). The WTRU may receive one or more time and/or frequency usage patterns to determine the period of validity of one or more configured unified TCI configurations per some units of time and/or frequency (for example, slots, bands, Bandwidth Parts (BWPs), subbands, CCs, and/or the like).

The WTRU may be configured and/or indicated with one or more BWP and/or CC lists containing one or more BWP and/or CC for simultaneous TCI updates. For example, a first list of the one or more BWP and/or CC lists may comprise first one or more BWP and/or CC indexes, and a second list of the one or more BWP and/or CC lists may comprise second one or more BWP and/or CC indexes, and so on. In an example, the WTRU may receive, via a first BWP and/or CC of the first list, a first indication of unified TCI(s). In response to receiving a first indication of unified TCIs, the WTRU may apply a first one or more unified TCI(s), based on the first indication, simultaneously to one or more, or all of the, the BWP and/or CC (for example including the first BWP and/or CC) of the first list. In an example, overhead and latency may be reduced in indicating the first one or more unified TCI(s) across multiple BWPs and/or CCs (for example, comprised in the first list) by using a single indication message (for example, the first indication). The WTRU may receive, via a second BWP and/or CC of the second list, a second indication of unified TCI(s). In response to the receiving, the WTRU may apply second one or more unified TCI(s), based on the second indication, simultaneously to one or more, or all of the, BWPs and/or CCs (including, for example, the second BWP and/or CC) of the second list. This may provide benefits in terms of overhead and latency reduction in indicating the second one or more unified TCI(s) across multiple BWPs and/or CCs (for example, comprised in the second list) by using a single indication message (for example, the second indication).

In an example, a list (for example, the first list, the second list, and/or the like) of the one or more BWP and/or CC lists may comprise one or more BWP and/or CC indexes, where a first index of the one or more BWP and/or CC indexes may be associated with (including, for example, correspond to, comprise, indicate, use, employ, be mapped/linked to, be configured/activated/indicated with, and/or the like) a single TRP to communicate with the WTRU, and a second index of the one or more BWP and/or CC indexes may be associated with (including, for example, correspond to, comprise, indicate, use, employ, be mapped/linked to, be configured/activated/indicated with, and/or the like) more than one TRP (for example, M-TRPs, for example, TRP1, TRP2, and/or the like) to communicate with the WTRU. Hereafter, for brevity, the list may be and/or may comprise a first list, where the first list may comprise at least a first BWP and/or CC index being associated with TRP1a (for example, as a single TRP) and/or a second BWP and/or CC index being associated with TRP2a and TRP2b (for example, as 2 TRPs), however the proposed solutions and processes may equally (or equivalently or extendedly, etc.) be employed for cases with other list (for example, a second list) of the one or more BWP and/or CC lists for simultaneous TCI updates, where the second list may comprise more than one BWP and/or CC indexes each being associated with a single TRP and/or more than one BWP and/or CC indexes each being associated with more than one TRP. The WTRU may be configured with a reference (unified) TCI state pool(s) (for example, via RRC and/or MAC-CE), where the reference TCI state pool(s) may be configured in a reference BWP and/or CC (for example, of the first list, being comprised in the first list, or being separately configured as being not comprised in the first list, etc.). In an example, the WTRU may determine that a configuration/parameter(s) for (unified) TCI state pool(s) is not configured for (for example, is absent in the PDSCH configuration (for example, PDSCH-config) of) the first BWP and/or CC index. In response to the determining, the WTRU may apply the reference (unified) TCI state pool(s) to the first BWP and/or CC index, for example, based on a parameter indicating the reference TCI state pool(s) or by a default/pre-defined/pre-configured WTRU behavior. In an example, a necessary unified TCI state pool(s) (among which, in an example, a unified TCI(s) may be indicated further) in the first BWP and/or CC index may be replaced by the reference (unified) TCI state pool(s) to be used for further indications of unified TCI(s) in the first BWP and/or CC associated with the first BWP and/or CC index.

In an example, the WTRU may expect, assume, identify, and/or determine (for example, a gNB shall configure, apply, and/or ensure) that the reference BWP and/or CC (for example, of the first list) may be configured/associated with M-TRPs, if at least one BWP and/or CC in the first list is configured/associated with M-TRPs. In an example, the WTRU may receive a first indication (for example, by a DCI) of more than one TCIs (which may be, for example, a unified TCI). An indication may be, for example, TCI #X and/or TCI #Y, (which may, for example, be out of the one or more reference TCI state pool(s) configured in the reference BWP and/or CC). In response to the receiving of the first indication, the WTRU may apply a first positioned unified TCI (for example, TCI #X) of the more than one TCIs (which may be, for example, unified TCIs) to be a unified TCI for communications with TRP1a, and may apply (in an example, simultaneously apply) the first positioned unified TCI (for example, TCI #X) and a second positioned unified TCI (for example, TCI #Y), respectively, and may be the two unified TCIs for communications with TRP2a and TRP2b. Reduced overhead and/or latency in indicating more unified one or more TCI(s) may result. For example, reduced overhead and/or latency may result in indicating more unified one or more TCI(s) for a M-TRP scenario and/or operation, across one or more BWPs and/or CCs (which may, for example, comprise a list, such as, for example, a first list, for simultaneous TCI updates) by using a single indication message (for example, the first indication). Each of the one or more BWPs and/or CCs may be employed and/or associated with a single TRP and/or more than one TRP, flexibly, based on an efficient strategy of network planning and/or deployment.

In an example, the WTRU may determine that a BWP and/or CC ID (for example, a BWP and/or CC indicator, BWP-ID, cell, and/or the like) of one or more source RS(s) with RS ID(s) (for example, for at least one large-scale wireless channel parameter and/or at least one quasi co-location (QCL) type parameter among Doppler spread, Doppler shift, average delay, delay spread, and/or spatial Rx), for example, in a QCL-related parameter (such as, for example, QCL-Info) comprised in an indicated TCI, may be absent. The indicated TCI may be, for example, a unified TCI. The indicated TCI may be, for example, the TCI #X and/or TCI #Y of the more than one unified TCIs indicated by the first indication. In an example, the BWP and/or CC ID is not comprised in the one or more source RS(s), for example, of the QCL-related parameter of TCI #X and/or TCI #Y. In response to the WTRU determining that a BWP and/or CC ID of one or more source RS(s) with RS ID(s) may be absent, the WTRU may apply, in a first BWP and/or CC (for example, associated with the first BWP and/or CC index), a first one or more RS(s) comprising, having, and/or associated, with one or more RS IDs, to be used for communications with the gNB via the first BWP and/or CC. In an example, the one or more RS ID(s) may be the same RS ID(s), and/or may be the same as one or more source RS(s) for QCL type(s) for the indicated unified TCI. In response to the WTRU determining that a BWP and/or CC ID of one or more source RS(s) with RS ID(s) may be absent, the WTRU may apply, in a second BWP and/or CC (for example, associated with the second BWP and/or CC index), a second one or more RS(s) comprising, having, and/or associated with, one or more RS ID(s) to be used for communications with the gNB via the second BWP and/or CC. For example, the second one or more RS(s) may be the same RS ID(s), and/or may be the same as the source RS(s) for QCL type(s) for the indicated unified TCI.

In an embodiment, the WTRU may determine that a first BWP and/or CC ID (for example, a BWP and/or CC indicator, bwp-ID, cell, and/or the like) of one or more source RS(s) with RS ID(s) comprised in an indicated TCI, is absent. For example, the indicated TCI may be an indicated unified TCI. For example, TCI #A may be a single unified TCI being indicated. For example, the first BWP and/or CC ID may not be comprised in the one or more source RS(s), for example, of the QCL-related parameter of TCI #A. In response to the WTRU determining that a first BWP and/or CC ID of one or more source RS(s), with RS ID(s) comprised in an indicated TCI, is absent, the WTRU may apply, in a first BWP and/or CC (associated with the first BWP and/or CC index), a first one or more RS(s) comprising, having, and/or associated with the RS ID(s) to be used for communications with a single TRP (for example, the TRP1a) (of the gNB) via the first BWP and/or CC. For example, the RS ID(s) may be the same RS ID(s) and/or may be the same as the source RS(s) for QCL type(s) for the indicated unified TCI (for example, TCI #A). In response to the WTRU determining that a first BWP and/or CCID of one or more source RS(s), with RS ID(s) comprised in an indicated TCI, is absent, the WTRU may apply, in a second BWP and/or CC (for example, associated with the second BWP and/or CC index), a second one or more RS(s) comprising, having, and/or associated with the RS ID(s) to be used for communications with a first TRP (for example, the TRP2a, a primary/default TRP) of multiple TRPs (for example, the TRP2a and TRP2b) via the second BWP and/or CC. For example, the RS ID(s) may be the same IDs, and/or may be the same as source RS(s) for QCL type(s) for the indicated unified TCI, for example, TCI #A. In an example, the WTRU may be (for example, explicitly) indicated and/or configured (for example, based on a parameter for the indication and/or an explicit TRP indicator) to apply an indicated TCI (which may be, for example, a unified TCI) to which TRP (for example, either TRP2a or TRP2b) of the multiple TRPs (for example, the TRP2a and TRP2b). For example, the WTRU may be indicated and/or configured when the WTRU receives a single TCI indication (which may be, for example, a unified TCI indication), for example, via a DCI, to apply to a BWP and/or CC employing more than one TRP (for example, being configured/activated). Operational efficiency and/or flexibility may result. For example, the gNB may flexibly configure and/or indicate a BWP and/or CC to the WTRU based on an efficient strategy of network planning/deployment of multiple TRPs, for example, in terms of geographical location of each TRP across different BWPs and/or CCs (for example, being flexibly configured and/or indicated to the WTRU).

In an example, the WTRU may determine that a first BWP and/or CC ID of first one or more source RS(s) with first RS ID(s) comprised in a first TCI, which may be, for example a unified TCI, (for example, TCI #A), and/or a second BWP and/or CC ID of second one or more source RS(s) with second RS ID(s) comprised in a second TCI, which may be, for example a unified TCI, (for example, TCI #B), of indicated TCIs, which may be, for example a unified TCI, (for example, TCI #A and TCI #B as more than one unified TCI being indicated) are absent. In response to the WTRU determining that a first BWP and/or CC ID and/or a second BWP and/or CC ID are absent, the WTRU may determine (for example, apply), in a first BWP and/or CC (for example, associated with the first BWP and/or CC index), first one or more RS(s) comprising and/or associated with the first RS ID(s) to be used for communications with a single TRP (for example, the TRP1a and/or the like) (of the gNB) via the first BWP and/or CC. In an example, the first RS ID(s) may be the same RS ID(s), and/or may be the same RS ID(s) as one or more source RS(s) for QCL type(s) for the indicated unified TCI, for example, TCI #A and/or the like.

In response to the WTRU determining that a first BWP and/or CC ID and/or a second BWP and/or CC ID are absent, the WTRU may determine (for example, apply) in a second BWP and/or CC (associated with the second BWP and/or CC index), second one or more RS(s) comprising (for example, having, associated with) the (same) first RS ID(s) (as source RS(s) for QCL type(s) for the indicated first unified TCI, for example, TCI #A) to be used for communications with a first TRP (for example, the TRP2a, a primary/default TRP), and third one or more RS(s) comprising, having, and/or associated with, the second RS ID(s) to be used for communications with a second TRP (for example, the TRP2b), of multiple TRPs (for example, the TRP2a and TRP2b) via the second BWP and/or CC. In an example, the one or more second RS ID(s) may be the same second RS ID(s), and/or may be the same as one or more source RS(s) for QCL type(s) for the indicated second unified TCI, for example, TCI #B and/or the like. In an example, the WTRU may be (for example, explicitly) indicated and/or configured, for example, based on a parameter for the indication and/or an explicit TCI indicator (which may be, for example a position indicator), to apply which indicated TCI, which may be a unified TCI, (for example, either TCI #A or TCI #B) of the indicated multiple unified TCIs (for example, TCI #A and TCI #B) to a single TRP (for example, TRP1a), for example, when the WTRU receives multiple unified TCIs being indicated, for example, via a DCI, to apply to a BWP and/or CC employing a single TRP (being configured/activated). Increased operational efficiency and flexibility may result, for example, in that the gNB may flexibly configure and/or indicate a BWP and/or CC to the WTRU based on an efficient strategy of network planning/deployment of multiple TRPs, for example, in terms of geographical location of each TRP across different BWPs and/or CCs (which may, for example, be flexibly configured and/or indicated to the WTRU).

In an embodiment, the WTRU may expect, assume, identify, and/or determine (for example, a gNB shall configure, apply, and/or ensure) that all the BWPs and/or CCs in the first list are configured with (for example, indicated, activated, and/or associated with) either more than one TRP (for example, as M-TRP) for each of all the BWPs and/or CCs of the first list or a single TRP (for example, as S-TRP) for each of all the BWPs and/or CCs of the first list, for example, where mixing S-TRP and M-TRP across the BWPs and/or CCs of the first list is not allowed by gNB's configuration to the WTRU. A reduction in implementation complexity (for example for the WTRU) and an increased efficiency may result, for example, by simplifying one or more allowed configurations for M-TRP operations and/or scenarios. In an example, the WTRU may expect, assume, identify, and/or determine (for example, a gNB shall configure, apply, and/or ensure) that one or more or all of the BWPs and/or CCs in the first list are configured with, indicated, activated, and/or associated with more than one TRP (for example, as M-TRP) for each of the one or more or all the BWPs and/or CCs of the first list. In an example, the WTRU may receive an Secondary Cell (SCell) (for example, CC, BWP, cell, BWP and/or CC) activation message (for example, via a MAC-CE), where the SCell activation message may comprise a parameter for choosing, selecting, and/or determining which TRP(s) (for example, either S-TRP with a TRP-ID indication or M-TRP) of the more than one TRP for an activated CC (for example, being activated based on the Scell activation message). Increased operational efficiency and flexibility may result, for example, in that the gNB may flexibly configure and/or indicate a BWP and/or CC being operated/used based on which TRP(s) to be communicated with the WTRU more dynamically (for example, on selecting which TRP(s) per BWP and/or CC). For example, the TRP(s) may be communicated with the WTRU via a MAC-CE.

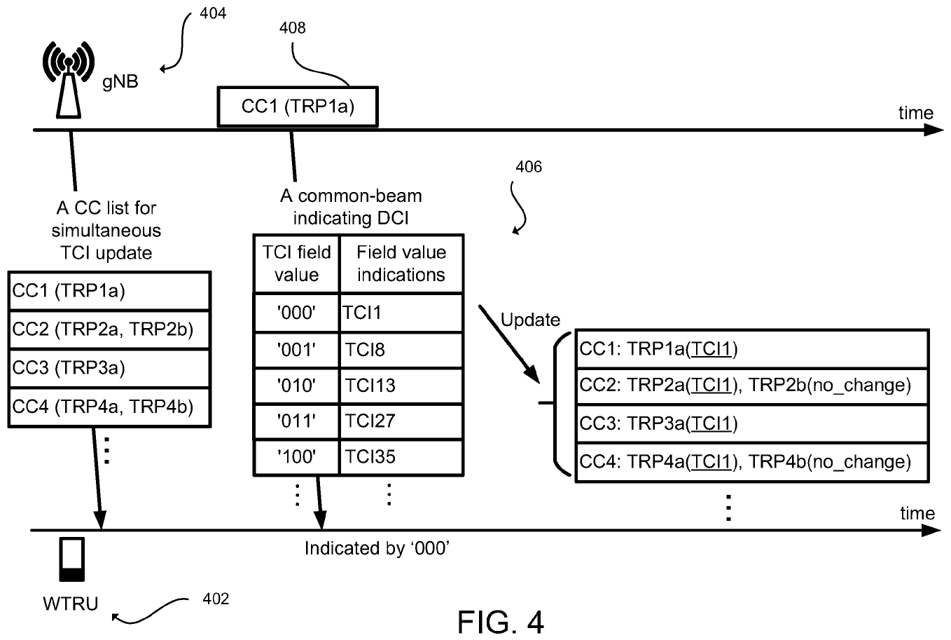

FIG. 4 is a diagram illustrating an example of unified TCI(s) with M-TRP across multiple BWPs and/or CCs. In an example, as shown in FIG. 4, the WTRU 402 may receive one or more configurations (for example, via RRC, from a gNB 404) that CC1 is configured with S-TRP (for example, TRP1a), CC2 is configured with M-TRP (for example, TRP2a, TRP2b), CC3 is configured with S-TRP (for example, TRP3a), CC4 is configured with M-TRP (for example, TRP4a, TRP4b), and/or those CCs (for example, CC1, CC2, CC3, CC4) are comprised in a list of the one or more BWP and/or CC lists for simultaneous TCI updates (e.g, being configured). The WTRU may receive a DCI 406 from a CC (for example, CC1 408) comprising a single TRP, indicating a unified TCI, for example, TCI1, based on a codepoint (for example, ‘000’) of a TCI field of the DCI. In response to the receiving the DCI, the WTRU may simultaneously update and/or apply the unified TCI (for example, TCI1) to multiple CCs in the list. In an example, this may occur where, in CC1, the TCI1 may be used/applied as a unified TCI for communications with the single TRP (for example, TRP1a). In some examples, this may occur where, in CC2, the TCI1 may be used/applied as a unified TCI for communications with a TRP (for example, TRP2a (by default, for example, as a primary and/or default TRP), or TRP2b if (for example explicitly) configured and/or indicated to do so) of the multiple TRPs. In some examples, this may occur where, in CC3, the TCI1 may be used/applied as a unified TCI for communications with the single TRP (for example, TRP3a). Further, in some examples, this may occur where, in CC4, the TCI1 may be used/applied as a unified TCI for communications with a TRP (for example, TRP4a (by default, for example, as a primary/default TRP), or TRP4b if (explicitly) configured/indicated to do so) of the multiple TRPs. Any one of the foregoing examples may occur in isolation or in conjunction with any one of the other examples, or all together. A beam and/or TCI to be used for communications with a TRP (for example, TRP2b, TRP4b, and/or the like) being not applied by the unified TCI may remain unchanged (for example, may maintain its current beam and/or TCI).

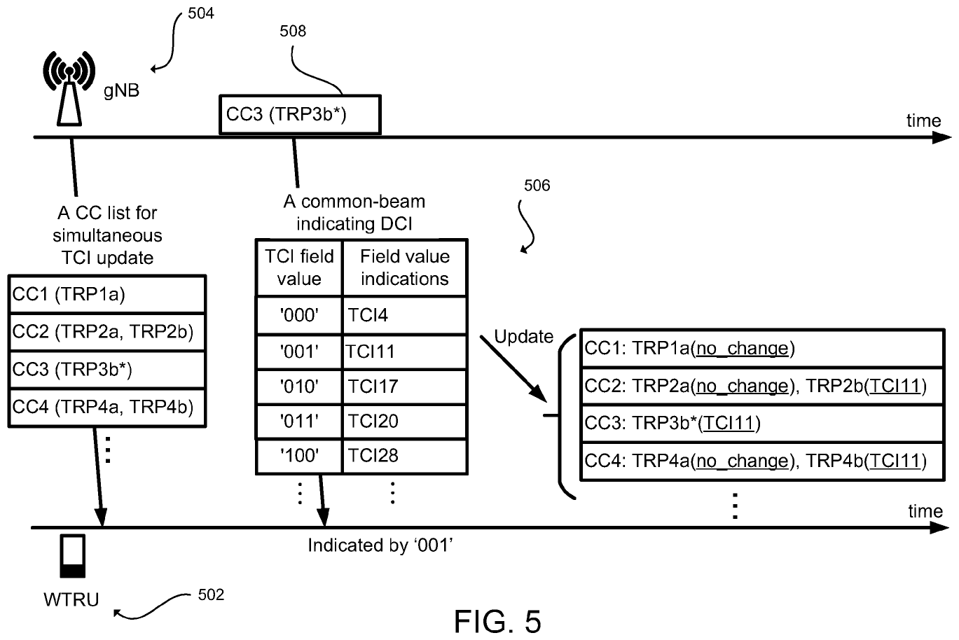

FIG. 5 is a diagram illustrating an example of unified TCI(s) with M-TRP across multiple BWPs and/or CCs. In an example, as shown in FIG. 5, the WTRU 502 may receive one or more configurations (for example, via RRC, from a gNB 504, and/or the like) that CC1 is configured with S-TRP (for example, TRP1a), CC2 is configured with M-TRP (for example, TRP2a, TRP2b), CC3 is configured with S-TRP (for example, TRP3b*), CC4 is configured with M-TRP (for example, TRP4a, TRP4b), and/or those CCs (for example, CC1, CC2, CC3, CC4) are comprised in a list of the one or more BWP and/or CC lists for simultaneous TCI updates (being configured). The WTRU may receive a DCI 506, from a CC (for example, CC3 508) comprising a single TRP, indicating a unified TCI, for example, TCI11, based on a codepoint (for example, ‘001’) of a TCI field of the DCI. In response to the receiving the DCI, the WTRU may simultaneously update and/or apply the unified TCI (for example, TCI11) to multiple CCs in the list. In some examples, in response to the receiving the DCI, the WTRU may simultaneously update and/or apply the unified TCI (for example, TCI11) to multiple CCs in the list where, in CC1, no beam/TCI may be changed/updated in response to the DCI. In some examples, in response to the receiving the DCI, the WTRU may simultaneously update and/or apply the unified TCI (for example, TCI11) to multiple CCs in the list, in CC2, the TCI11 may be used/applied as a unified TCI for communications with a TRP (for example, TRP2b based on being (explicitly) configured/indicated to do so) of the multiple TRPs. Further, in some examples, in response to the receiving the DCI, the WTRU may simultaneously update and/or apply the unified TCI (for example, TCI11) to multiple CCs in the list where, in CC3, the TCI11 may be used/applied as a unified TCI for communications with the single TRP (for example, TRP3b*).

For example, CC3 may be configured with a single-TRP (“S-TRP”) (TRP3b*). The TRP3b* may have an association with secondary TRP in another CC with MTRP. In an example, this may occur where, in CC4, the TCI11 may be used/applied as a unified TCI for communications with a TRP (for example, TRP4b based on being (explicitly) configured/indicated to do so) of the multiple TRPs. Any one of the foregoing examples may occur in isolation or in conjunction with any one of the other examples, or all together. In an example, a BWP and/or CC (e.g., being configured with a single TRP, for example, the TRP3b*) may be (for example, explicitly) configured, associated, and/or indicated with a single TRP (for example, the TRP3b*) may have an association with a second position and/or order of a TRP of multiple TRPs in other BWP and/or CC employing more than one TRP (M-TRP). The second position/order of the TRP may be, indicate, and/or comprise, a TRP which is not a primary and/or default TRP. Increased operational efficiency and/or flexibility may occur, for example, in that the gNB may flexibly configure and/or indicate a BWP and/or CC to the WTRU based on an efficient strategy of network planning/deployment of multiple TRPs, for example, in terms of geographical location of each TRP across different BWPs and/or CCs. For example, TRP1a, TRP2a, and TRP4a may be located on a first geographical position (which may be, for example, in proximity) and TRP2b, TRP3b*, TRP4b may be located on a second geographical position (which may be, for example, in proximity to the first geographical location), so that an indicated unified TCI may be applicable simultaneously for TRPs being located on a same geographical position, which further provides benefits in terms of overhead reduction in indicating a unified TCI across multiple BWPs and/or CCs.

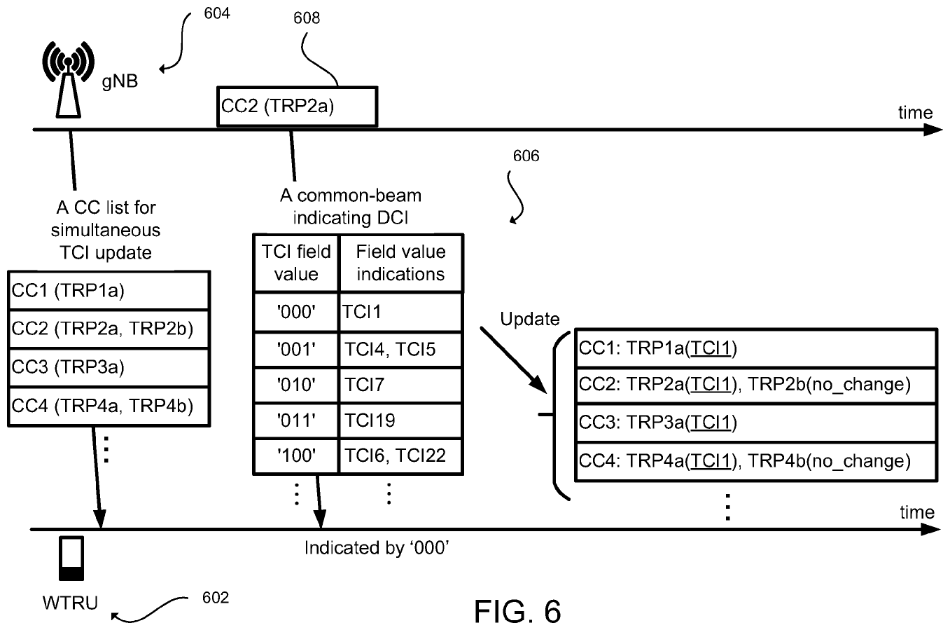

FIG. 6 is a diagram illustrating an example of unified TCI(s) with M-TRP across multiple BWPs and/or CCs. In an example, as shown in FIG. 6, the WTRU 602 may receive one or more configurations (for example, via RRC, from a gNB 604) that CC1 is configured with S-TRP (for example, TRP1a), CC2 is configured with M-TRP (for example, TRP2a, TRP2b, and/or the like), CC3 is configured with S-TRP (for example, TRP3a), CC4 is configured with M-TRP (for example, TRP4a, TRP4b, and/or the like), and/or those CCs (for example, CC1, CC2, CC3, CC4, and/or the like) are comprised in a list of the one or more BWP and/or CC lists for simultaneous TCI updates (e.g., being configured). The WTRU may receive a DCI 606, from a CC (for example, CC2 608) comprising more than one TRP, indicating a unified TCI, for example, TCI1, based on a codepoint (for example, 000) of a TCI field of the DCI, from a first TRP (for example, TRP2a) of the more than one TRP.

In response to the receiving the DCI, the WTRU may simultaneously update and/or apply the unified TCI (for example, TCI1) to multiple CCs in the list. For example, in response to the receiving the DCI, the WTRU may simultaneously update and/or apply the unified TCI (for example, TCI1) to multiple CCs in the list, in a scenario where, in CC1, the TCI1 may be used/applied as a unified TCI for communications with the single TRP (for example, TRP1a). For example, in response to the receiving the DCI, the WTRU may simultaneously update and/or apply the unified TCI (for example, TCI1) to multiple CCs in the list, in a scenario where, in CC2, the TCI1 may be used/applied as a unified TCI for communications with a TRP (for example, TRP2a (by default, for example, as a primary/default TRP), or TRP2b if (explicitly) configured/indicated to do so) of the multiple TRPs. For example, in response to the receiving the DCI, the WTRU may simultaneously update and/or apply the unified TCI (for example, TCI1) to multiple CCs in the list, in a scenario where, in CC3, the TCI1 may be used/applied as a unified TCI for communications with the single TRP (for example, TRP3a). For example, in response to the receiving the DCI, the WTRU may simultaneously update and/or apply the unified TCI (for example, TCI1) to multiple CCs in the list, in a scenario where, in CC4, the TCI1 may be used/applied as a unified TCI for communications with a TRP (for example, TRP4a (by default, for example, as a primary/default TRP), or TRP4b if (explicitly) configured/indicated to do so) of the multiple TRPs. Any one of the foregoing examples may occur in isolation or in conjunction with any one of the other examples, or all together. In an example, a beam and/or TCI to be used for communications with a TRP (for example, TRP2b, TRP4b) being not applied by the unified TCI may remain unchanged (for example, may maintain its current beam and/or TCI). In an example, in response to the receiving the DCI, the WTRU may (be configured to) simultaneously update and/or apply the unified TCI (for example, TCI1) to one or more CCs (for example, CC1 and/or CC3), each comprising a single TRP (for example, each not comprising more than one TRP), and/or not update and/or apply the unified TCI (for example, TCI1) to at least one TRP in CC2 and CC4 (for example, because each of CC2 and CC4 comprises more than one TRP).

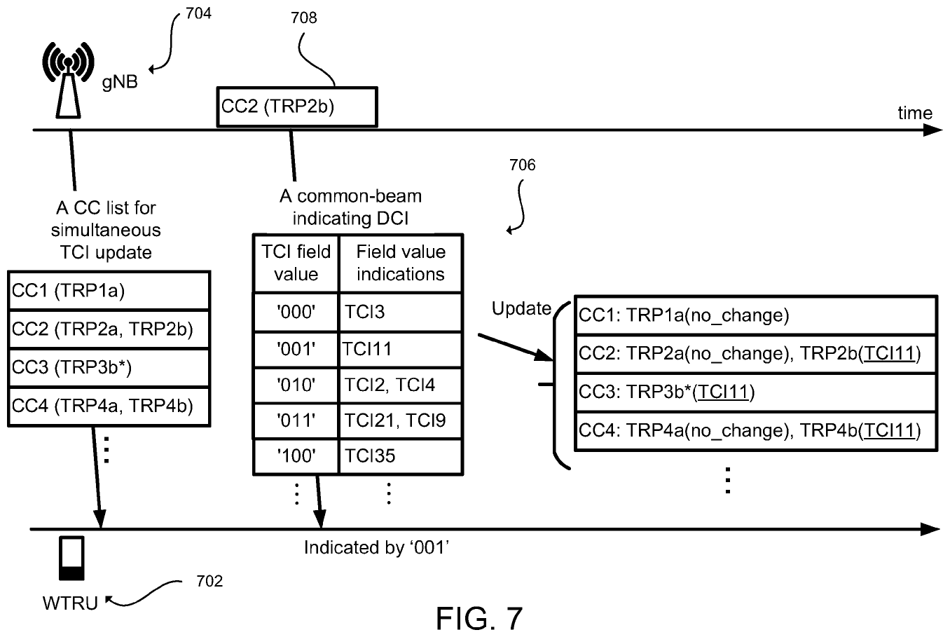

FIG. 7 is a diagram illustrating an example of TCI(s) with M-TRP across multiple BWPs and/or CCs. In an example, as shown in FIG. 7, the WTRU 702 may receive one or more configurations (for example, via RRC, from a gNB 704) that CC1 is configured with S-TRP (for example, TRP1a), CC2 is configured with M-TRP (for example, TRP2a, TRP2b), CC3 is configured with S-TRP (for example, TRP3b*), CC4 is configured with M-TRP (for example, TRP4a, TRP4b), and/or those CCs (for example, CC1, CC2, CC3, CC4) are comprised in a list of the one or more BWP and/or CC lists for simultaneous TCI updates (being configured). For example, CC3 may be configured with S-TRP (TRP3b*). The TRP3b* may have an association with secondary TRP in other CC with MTRP. The WTRU may receive a DCI 706, from a CC (for example, CC2 708) comprising more than one TRP, indicating a unified TCI, for example, TCI11, based on a codepoint (for example, ‘001’) of a TCI field of the DCI, from a second TRP (for example, TRP2b) of the more than one TRP.

In response to the receiving the DCI, the WTRU may simultaneously update/apply the unified TCI (for example, TCI11) to multiple CCs in the list. In response to the receiving the DCI, the WTRU may simultaneously update/apply the unified TCI (for example, TCI11) to multiple CCs in the list, where, in CC1, no beam/TCI may be changed/updated in response to the DCI, for example, based on determining that the unified TCI (TCI11) is indicated from a second position/order of TRP (TRP2b) in CC2 and TRP1a in CC1 may corresponds to a first position/order of TRP (TRP1a, for example, as a primary/default TRP). For example, in response to the receiving the DCI, the WTRU may simultaneously update/apply the unified TCI (for example, TCI11) to multiple CCs in the list, where, in CC2, the TCI11 may be used/applied as a unified TCI for communications with a TRP (for example, TRP2b as an aligned (second) position/order of TRP) of the multiple TRPs. For example, in response to the receiving the DCI, the WTRU may simultaneously update/apply the unified TCI (for example, TCI11) to multiple CCs in the list, where, in CC3, the TCI11 may be used/applied as a unified TCI for communications with the single TRP (for example, TRP3b* based on being (explicitly) configured/indicated to do so). For example, in response to the receiving the DCI, the WTRU may simultaneously update/apply the unified TCI (for example, TCI11) to multiple CCs in the list, where, in CC4, the TCI11 may be used/applied as a unified TCI for communications with a TRP (for example, TRP4b as an aligned (second) position/order of TRP) of the multiple TRPs.

Any one of the foregoing examples may occur in isolation or in conjunction with any one of the other examples, or all together. In an example, a BWP and/or CC (e.g., being configured with a single TRP, for example, the TRP3b*) may be (explicitly) configured, associated, and/or indicated with that the single TRP (for example, the TRP3b*) may have an association with a second position/order of a TRP of multiple TRPs in other BWP and/or CC employing more than one TRP (M-TRP). The second position/order of the TRP may be (for example, indicate, comprise) a TRP which is not a primary/default TRP. This may provide benefits in terms of improving an operational efficiency and flexibility in that the gNB may flexibly configure/indicate a BWP and/or CC to the WTRU based on an efficient strategy of network planning/deployment of multiple TRPs, for example, in terms of geographical location of each TRP across different BWPs and/or CCs (for example, where TRP1a, TRP2a, and TRP4a may be located on a first geographical position (in proximity) and TRP2b, TRP3b*, TRP4b may be located on a second geographical position (in proximity), so that an indicated unified TCI may be applicable simultaneously for TRPs being located on a same geographical position, which further provides benefits in terms of overhead reduction in indicating a unified TCI across multiple BWPs and/or CCs).

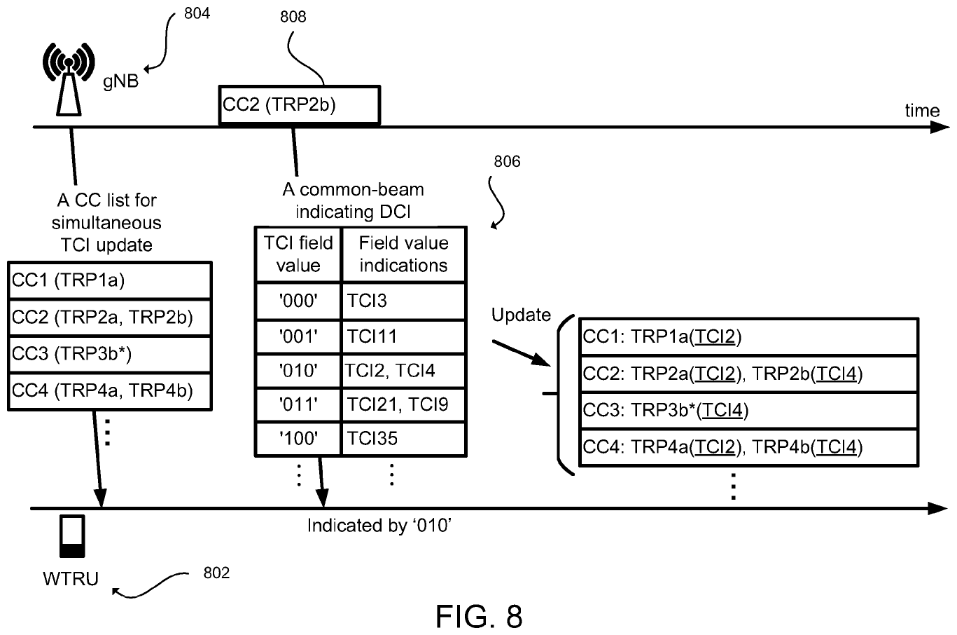

FIG. 8 is a diagram illustrating an example unified one or more TCI(s) with M-TRP across multiple BWPs and/or CCs. In an example, as shown in FIG. 8, the WTRU 802 may receive one or more configurations (for example, via RRC, from a gNB 804) that CC1 is configured with S-TRP (for example, TRP1a), CC2 is configured with M-TRP (for example, TRP2a, TRP2b), CC3 is configured with S-TRP (for example, TRP3b*), CC4 is configured with M-TRP (for example, TRP4a, TRP4b), and/or those CCs (for example, CC1, CC2, CC3, CC4) are comprised in a list of the one or more BWP and/or CC lists for simultaneous TCI updates (being configured). In an example, CC3 may be configured with S-TRP (TRP3b*). The TRP3b* may have an association with secondary TRP in other CC with MTRP. The WTRU may receive a DCI 806 from a CC (for example, CC2 808) comprising more than one TRP, indicating more than one unified TCI, for example, TCI2 and TCI4, based on a codepoint (for example, ‘010’) of a TCI field of the DCI, from a second TRP (for example, TRP2b) of the more than one TRP.

In response to the receiving the DCI, the WTRU may simultaneously update/apply the more than one unified TCI (for example, TCI2 and TCI4) to multiple CCs in the list. For example, in response to the receiving the DCI, the WTRU may simultaneously update and/or apply the more than one unified TCI (for example, TCI2 and TCI4) to multiple CCs in the list. For example, in response to the receiving the DCI, the WTRU may simultaneously update and/or apply the more than one unified TCI to multiple CCs in the list where, in CC1, the TCI2 (corresponding to a first position/order of TRP) may be used/applied as a unified TCI for communications with a TRP (for example, TRP1a based on the (aligned) first position/order of TRP). For example, in response to the receiving the DCI, the WTRU may simultaneously update and/or apply the more than one unified TCI to multiple CCs in the list where, in CC2, the TCI2 (corresponding to a first position/order of TRP) may be used/applied as a first unified TCI for communications with a first TRP (for example, TRP2a based on the (aligned) first position/order of TRP) and the TCI4 (corresponding to a second position/order of TRP) may be used/applied as a second unified TCI for communications with a second TRP (for example, TRP2b based on the (aligned) second position/order of TRP). For example, in response to the receiving the DCI, the WTRU may simultaneously update and/or apply the more than one unified TCI to multiple CCs in the list where, in CC3, the TCI4 (corresponding to a second position/order of TRP) may be used/applied as a unified TCI for communications with the single TRP (for example, TRP3b* based on being (explicitly) configured/indicated to do so, for example, as being aligned with the second position/order of TRP). For example, in response to the receiving the DCI, the WTRU may simultaneously update and/or apply the more than one unified TCI to multiple CCs in the list where, in CC4, the TCI2 (corresponding to a first position/order of TRP) may be used/applied as a first unified TCI for communications with a first TRP (for example, TRP4a based on the (aligned) first position/order of TRP) and the TCI4 (corresponding to a second position/order of TRP) may be used/applied as a second unified TCI for communications with a second TRP (for example, TRP4b based on the (aligned) second position/order of TRP). Any one of the foregoing examples may occur in isolation or in conjunction with any one of the other examples, or all together.

A BWP and/or CC (being configured with a single TRP, for example, the TRP3b*) may be (for example explicitly) configured, associated, and/or indicated with that the single TRP (for example, the TRP3b*) may have an association with a second position and/or order of a TRP of multiple TRPs in other BWP and/or CC employing more than one TRP (for example, M-TRP). The second position and/or order of the TRP may be (for example, indicate, comprise, and/or the like) a TRP which is not a primary and/or default TRP. This may provide benefits in terms of improving an operational efficiency and flexibility in that the gNB may flexibly configure/indicate a BWP and/or CC to the WTRU based on an efficient strategy of network planning/deployment of multiple TRPs, for example, in terms of geographical location of each TRP across different BWPs and/or CCs. For example, where TRP1a, TRP2a, and/or TRP4a may be located on a first geographical position (in proximity) and TRP2b, TRP3b*, TRP4b may be located on a second geographical position (in proximity), so that an indicated unified TCI may be applicable simultaneously for TRPs being located on a same geographical position, which further provides benefits in terms of overhead reduction in indicating a unified TCI across multiple BWPs and/or CCs.

The carrier aggregation (CA) and beam forming may be closely related to RF frontend WTRU capabilities as Common Beam Management (CBM) and/or Independent Beam Management (IBM). As some of the Component Carriers (CCs) may be configured with M-TRP transmission and/or reception, under a unified TCI concept some of the overhead may be reduced by using rules over CC grouping that may be related to Cell Groups (CGs), RF chains availability (WTRU capability). As the beam may be the same for a group of cells, a common beam management may be assumed, and thus the QCL assumption may be the same or mapping to similar RS. In an example the cells part of a CG may be treated using a commonality, for example, of a common bean management. In an example, a timing advance group (TAG) may be used inter-changeably with a CG as cell grouping criteria. In an embodiment, an M-TRP configuration for CC may comprise a primary TRP (P-TRP) and secondary TRP (S-TRP). The cells may be grouped as MCG (Main Cell Group) and SCG (Secondary Cell Group) where each group has a Primary Cell (PCell) and/or Primary Special Cell (PSCell) respectively and secondary cells in each group. In the following solutions we will describe the operations within MCG, as the SCGs may be just similar with a different notation.

In an example, a DCI received on a PCell that updates the TCI state may update a part of or the entire cell group. For example, a DCI received on a secondary cell may update the TCI for that secondary cell. In an example, the WTRU may be configured with a first CG comprising CC1, CC2, and/or CC3, where CC1 is a PCell, CC2 is a first SCell, and/or CC3 is a second SCell. The WTRU may receive, via CC1 (for example, a PCell), a DCI (indicating unified TCI(s). In response receiving a DCI, the WTRU may apply and/or update the indicated unified TCI(s) simultaneously to CC1, CC2, and/or CC3 (for example, a part of or all of the CCs in the first CG). The WTRU may receive, via CC2 (for example, SCell), a second DCI (for example, indicating unified TCI(s). In response to the receiving the second DCI, the WTRU may apply/update the indicated unified TCI(s) only to the CC2 (for example, from which the second DCI is received). If in a CG a cell or more are configured with M-TRP, but not the PCell, then a DCI received on PCell may update the TCI of entire CG and the configured primary TRPs (P-TRPs) for the CCs that have M-TRP configuration given by RRC and active. For example, the Pcell may not have an S-TRP configured, and a part of or all of the S-TRPs configured in this CG may be updated by DCIs of the first cell index after PCell that has a configured S-TRP.

In an example, a designated SCell may be S-TRP drive the TCI updates. A designated SCell may be signaled by RRC and/or by MAC along with the active TCIs. In an example, the DCI received on any SCells carrying the TCI update may have a flag for S-TRPs that will allow for one or more or all of the S-TRPs TCI to update. In an example, if PCell has an M-TRP configuration a DCI received on PCell may update the TCI for the S-TRP (secondary TRP) and all the configured S-TRPs of the active CCs in the CG and the TCI of the Pcell P-TRP and the rest of the CCs and P-TRPs were configured and active. In an example, a DCI received on any SCell of a CG carrying a flag indicating updates for P-TRP or S-TRP may update all configured and active P-TRP or S-TRPs in a CG. In an example, a MAC-CE activation may indicate the P-TRP or S-TRP (for example, if M-TRP is configured by RRC for the CC). As an example, this indication may be a flag, zero for P-TRP and 1 for S-TRP. In an example, a CC configured with M-TRP operation by RRC, may activate both P-TRP and S-TRP if there are other M-TRP configured CCs that have both P-TRP and S-TRP activated. In an example, it may activate the CC only with P-TRP which is the default TRP and wait for the first DCI in the CG that may activate the S-TRP through a TCI codepoint that is a for a M-TRP related configuration. In an example, a Beam Application Time (BAT) may be the same for all the cell within a CG.

In an embodiment, the WTRU may determine a TCI state applicable to a transmission or reception by first determining a Unified TCI state instance applicable to this transmission or reception, then determining a TCI state corresponding to the Unified TCI state instance. A transmission may consist of at least PUCCH, PUSCH, and/or SRS. A reception may consist of at least PDCCH, PDSCH, and/or CSI-RS. A Unified TCI state instance may also be referred to Unified TCI (UTCI) instance, TCI instance, TCI state instance, TCI state group, TCI state process, unified TCI pool, a group of TCI states, a set of time-domain instances/stamps/slots/symbols, and/or a set of frequency-domain instances, RBs, and/or subbands, and the like. In some solutions, a Unified TCI state instance may be equivalent or identified to a CORESET Pool identity (e.g., CORESETPoolIndex, a TRP indicator, and/or the like).

In an example, the WTRU may determine whether a Unified TCI state instance is applicable to a transmission or reception and/or the identity of a Unified TCI state instance applicable to a transmission or reception based on one of the following solutions. For example, if the WTRU determines that a Unified TCI state instance is not applicable to a transmission or reception, the WTRU may set a spatial filter according to a legacy solution. In an example, the WTRU may receive RRC signaling configuring the Unified TCI state instance applicable to a transmission or reception. Such configuration may, for example, be specific to a bandwidth part or a serving cell. For example, if the WTRU does not receive configuration for an applicable Unified TCI state instance, the WTRU may determine that no Unified TCI state instance is applicable. In an example, the WTRU may determine a default Unified TCI state instance. Such a default Unified TCI state instance may, for example, be pre-defined or configured separately.

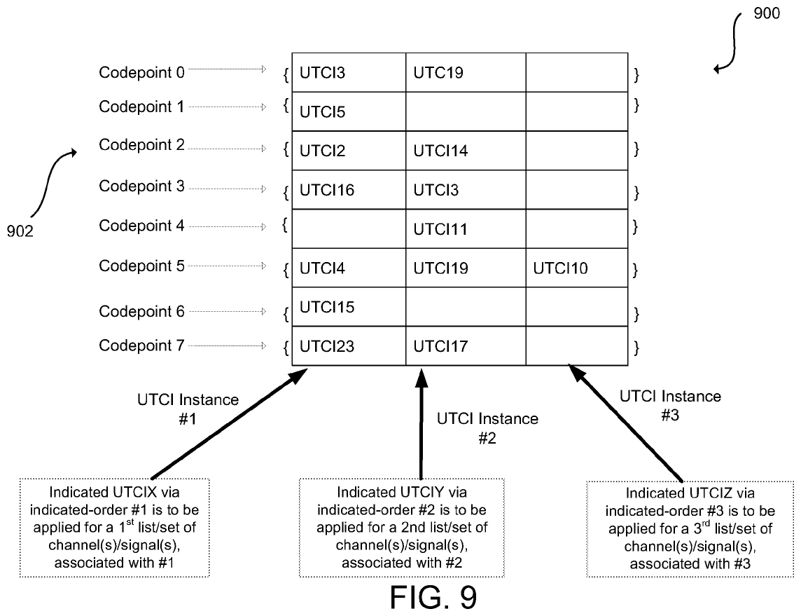

FIG. 9 is a diagram illustrating an example of a TCI field (e.g., 3-bit) table 900 for a DCI, indicating at least one UTCI. In an example, the WTRU may receive a MAC-CE signaling (e.g., a MAC-CE command or message) activating/updating/indicating the Unified TCI state instance applicable to a transmission or reception. In an example, a Unified TCI (UTCI) state instance (e.g., UTCI instance) may correspond to (e.g., be associated with, point to, or indicate) a column of the TCI field table for the DCI.

In an example, each of the codepoints 902 (e.g., 0, 1, . . . , 7 in FIG. 9) of the TCI field may be associated with up to S (>=1) UTCI(s) (e.g., activated via a MAC-CE), where a value of S may correspond to the maximum number of UTCI instances (e.g., S=3 in the figure). The UTCI instance may be regarded as a position index (e.g., based on an indicated order of UTCI(s), corresponding to a column in the figure) for a codepoint 902 of the TCI field. In an example, the WTRU may be configured/indicated with an association between the UTCI instance (e.g., UTCI-indicated-order #J where J=1, 2, . . . , or S) (e.g., for a codepoint 902 of the TCI field) and (e.g., a list/set of) target channel(s)/signal(s). For example, Order #J=1 (e.g., UTCI instance #1) may have an association with a first group of CORESETs, a first group of CSI-RSs, a first group of PUCCH resources, PDSCHs/PUSCHs for TRP1, etc. Order #J=2 (e.g., UTCI instance #2) may have an association with a second group of CORESETs, a second group of CSI-RSs, a second group of PUCCH resources, PDSCHs/PUSCHs for TRP2, etc. The WTRU may receive a configuration (or indication) of a value of S, which may be based on (e.g., may correspond to) the max number of UTCIs that can be simultaneously indicated by a codepoint of the TCI field of a DCI. The WTRU may receive different configurations (or indications) within the same UTCI instance and/or across different codepoints. For example, each configuration (or indication) may be associated with a different applicable list/set of channel(s)/signal(s). In some examples, a default UTCI instance #J may be set (e.g., pre-defined or pre-configured) per target channel/signal (e.g., where the default UTCI instance may be the UTCI instance #1 (e.g., a lowest value of J). In an example, if a PUCCH resource is configured, e.g., by default, it may follow an indicated UTCI with #J=1 position (e.g., mapped to UTCI instance #1). The default may be #J, per target channel/signal, corresponding to the target channel/signal's TRP index (TRP #J), CORESETpoolIndex, or TAG index, etc., if it is known/configured for the target channel/signal. For example, if the PUCCH resource is configured for TRP2, the PUCCH resource may follow an indicated UTCI with #J=2 position (e.g., mapped to UTCI instance #2) (e.g., by default). In an example, the default may not be #J=1. For example, the default may be #J=1 or may be #J=2, e.g., depending on target channel/signal if the target channel (e.g., PUSCH, PDSCH, etc.) is associated with TRP #J (=1 or 2) (which may be known/configured to the WTRU). For example, the WTRU may be scheduled to receive a PDSCH and the WTRU may determine that the PDSCH is from TRP2 (#J=2) (e.g., via a CORESETpoolIndex value set to ‘1’, not ‘0’). Then, for example, the WTRU may also apply the default to be #J=2, which may indicate that the WTRU reads a second UTCI instance (J=2).

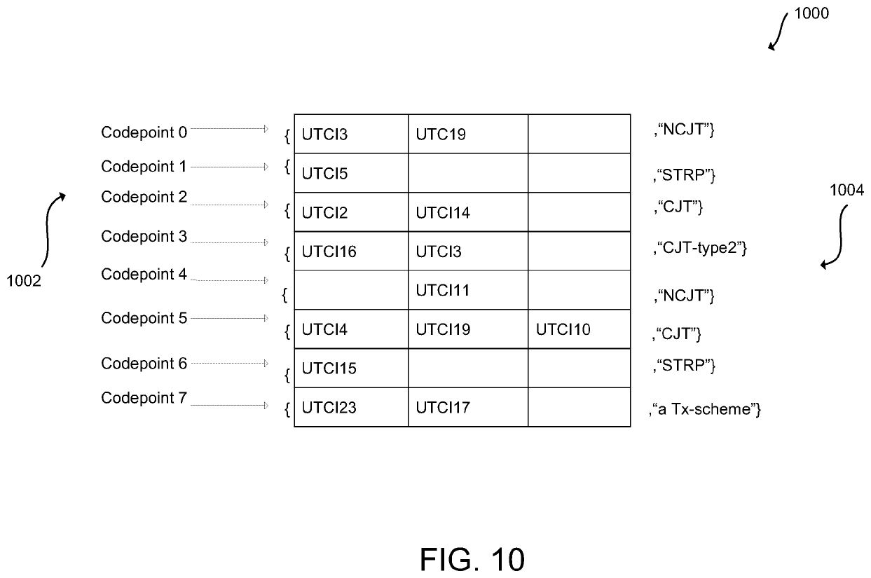

FIG. 10 is a diagram illustrating an example of a TCI-codepoint-wise Tx/Rx scheme selection table 1000. The WTRU may receive a configuration (or indication) that one of the codepoints 1002 of TCI field for a DCI is associated with one of the applicable Tx (and/or Rx) schemes 1004. the applicable Tx (and/or Rx) scheme may comprise one or more of: STRP (single TRP) Tx and/or Rx; NCJT (non-coherent JT) as an MTRP scheme; CJT (coherent JT) Type 1 as an MTRP scheme, based on single frequency network (SFN) type of CJT; CJT Type 2 as an MTRP scheme; a Tx (and/or Rx) scheme that may be configurable by a gNB; and/or the like. the WTRU may receive a configuration (or indication) that a codepoint of TCI field for a DCI may be associated with STRP (e.g., single TRP) Tx and/or Rx. In some examples, the WTRU may receive a configuration (or indication) that a codepoint of TCI field for a DCI may be associated with NCJT (non-coherent JT) as an MTRP scheme. For example, upon receiving a codepoint 0 (e.g., shown in FIG. 10) at the WTRU, for reception of a scheduled PDSCH (e.g., transmitted from two TRPs as NCJT), a first set of (spatial-domain) layer(s) of the PDSCH may be applied by a first-indicated UTCI (e.g., UTCI3), and a second set of layer(s) of the PDSCH may be applied by a second-indicated UTCI (e.g., UTCI9). The WTRU may receive the PDSCH by using the first-indicated UTCI for decoding the first set of layer(s) and the second-indicated UTCI for decoding the second set of layer(s).

The WTRU may receive a configuration (or indication) that a codepoint of TCI field for a DCI may be associated with CJT (coherent JT) Type 1 as an MTRP scheme, for example, based on single frequency network (SFN) type of CJT. For example, upon receiving a codepoint 2 (shown in FIG. 10) at the WTRU, for reception of a scheduled PDSCH (transmitted from two TRPs as CJT (Type 1)), the WTRU may assume that the PDSCH DM-RS port(s) may be QCLed with the DL RSs of the indicated at least one UTCI (e.g., UTCI2 and UTCI14) with respect to QCL-TypeA (e.g., as an SFN-PDSCH). The WTRU may receive the PDSCH by using both UTCI2 and UTCI14 in an single frequency network (SFN) manner based on an assumed QCL type, e.g., QCL-TypeA which may indicate at least one of {Average delay, delay spread, Doppler shift, Doppler spread}. In an example, the WTRU may receive a configuration (or indication) that a codepoint 1002 of a TCI field for a DCI may be associated with CJT Type 2 as an MTRP scheme. For example, upon receiving a codepoint 3 (in FIG. 10) at the WTRU, for reception of a scheduled PDSCH (transmitted from two TRPs as CJT (Type 2)), the WTRU may assume that the PDSCH DM-RS port(s) may be QCLed with the DL RSs of the first indicated UTCI (UTCI16) with respect to QCL-TypeA and the DL RSs of the rest of the at least one UTCI (UTCI3) with respect to QCL-TypeB. The WTRU may receive the PDSCH by using both UTCI16 and UTCI3 in a CJT manner based on different combinations of QCL properties being applied for each UTCI, e.g., using UTCI16 applied with QCL-TypeA which may indicate at least one of {Average delay, delay spread, Doppler shift, Doppler spread} and using UTCI3 applied with QCL-TypeB which may indicate at least one of {Doppler shift, Doppler spread}. In some examples, the WTRU may receive a configuration (or indication) that a codepoint of TCI field for a DCI may be associated with A Tx (and/or Rx) scheme that may be configurable by a gNB.

The WTRU may receive a configuration (or indication) which may inform the WTRU of channel/signal-specific WTRU behaviors, for example, upon receiving a TCI-codepoint that indicates at least one UTCI and/or a Tx/Rx scheme, where one or more of following may apply. In an example, in operation 1 (upon receiving TCI-codepoint 2 in the figure as an example), the WTRU may monitor a first group of CORESETs using UTCI2, and a second group of CORESETs using UTCI14, while the WTRU may receive a scheduled PDSCH based on using both of UTCI2 and UTCI14 (e.g., as a CJT-PDSCH reception). In an example, in operation 2 (upon receiving TCI-codepoint 2 in the figure as an example), the WTRU may monitor all CORESETs (e.g., all configured CORESETs to be monitored) using a first-indicated UTCI (UTCI2), while the WTRU may receive a scheduled PDSCH based on using both of UTCI2 and UTCI14 (e.g., as a CJT-PDSCH reception). In an example, in operation 3 (upon receiving TCI-codepoint 2 in the figure as an example), the indicated codepoint 2 (e.g., with CJT, or for cases of any other PDSCH associated with a TCI-codepoint) may not affect to (e.g., any) CORESET receptions, while the WTRU may receive a scheduled PDSCH based on using both of UTCI2 and UTCI14 (e.g., as a CJT-PDSCH reception). For example, this may mean that all CORESETs may be monitored with a current UTCI (e.g., UTCI5 if it is a previously indicated UTCI by a second codepoint). In an example, the WTRU may be configured (or indicated) to follow at least one among the Operation 1, 2, and 3, at least in terms of the control channel monitoring behavior (e.g., via one or more CORESETs).

A scheme selection may be applied upon receiving a DCI indicating the TCI-codepoint, but an actual application time of the indicated at least one UTCI (by the TCI-codepoint) may be applied based on a configured (or indicated) beam application time (BAT) parameter (e.g., which may be defined or pre-configured to be applied after ACK transmission timing in response to receiving the DCI).

In an example, RRC may configure the Unified TCI state instance applicable to PUCCH transmissions. For example, RRC may configure the Unified TCI state instance applicable to a scheduling request (SR) resource. The configuration may be specific to each SR resource or common to all SR resources of a PUCCH configuration. For example, RRC may configure the Unified TCI state instance applicable to a resource for periodic CSI reporting. The configuration may be included as part of the CSI reporting configuration or as part of the PUCCH resource configuration. For example, RRC may configure the Unified TCI state instance applicable to a resource for HARQ-ACK reporting. The configuration may be specific to each PUCCH resource or common to all PUCCH resources of a PUCCH configuration associated to a HARQ-ACK codebook. For example, RRC may configure the Unified TCI state instance applicable to all resources following a specific PUCCH format. For example, RRC may configure the Unified TCI state instance applicable to PUCCH resources carrying a payload within a specific range. For example, RRC may configure a payload threshold for at least one PUCCH resource and configure a first Unified TCI state instance for PUCCH carrying a payload lower than the threshold and a second Unified TCI state instance for PUCCH carrying a payload higher than the threshold. In an example, if the WTRU is configured with two PUCCH-config parameters corresponding to respective HARQ-ACK codebooks for URLLC, each PUCCH-config may include and/or comprise a configuration of which unified TCI pool being associated with. In this case, the priority indication of the DCI may be overloaded to indicate the unified TCI pool.

In an example, RRC can configure the Unified TCI state instance applicable to certain SRS transmissions. The configuration may be specific to an SRS resource or to an SRS resource set. In an embodiment, RRC can configure the Unified TCI state instance applicable to PUSCH transmissions. For example, RRC can configure the Unified TCI state instance applicable to a configured grant (CG) Type 1 or Type 2. The configuration may be specific to each CG configuration or common to all CG configurations. For example, RRC can configure the Unified TCI state instance applicable to a Unified TCI state instance may be explicitly configured as part of a CG configuration. For example, the WTRU may follow a Unified TCI state instance configured as part of an SRS resource or SRS resource set configured for the CG configuration.

In an example, RRC may configure the Unified TCI state instance applicable to PDCCH receptions. The configuration (e.g. by a parameter of “PDCCH TCI state usage”) may be provided for each Coreset (e.g., Coreset group) or each Coreset Pool index. In an example, the Coreset Pool index may be identical to the Unified TCI state instance. For example, the configuration may be provided for each Search space, DCI format, DCI size, and/or the like.

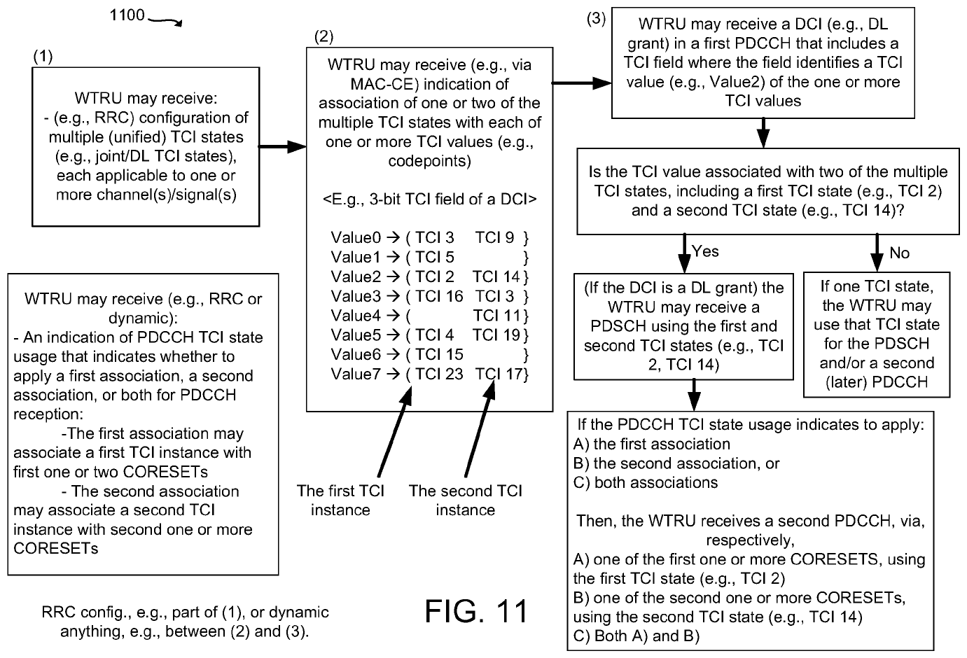

FIG. 11 is a diagram illustrating an example diagram 1100 of PDCCH TCI state usage that associates a CORESET with a TCI state instance. For example, as shown in FIG. 11, the WTRU may receive information, e.g., by a parameter of “PDCCH TCI state usage,” that indicates that one or more of: (i) a first CORESET is associated with a first transmission configuration indicator (TCI) state instance, and/or (ii) a second CORESET is associated with a second TCI state instance. The WTRU may receive an information element (e.g., by an RRC (or other higher-layer) parameter, e.g., “PDCCH TCI state usage”) that indicates whether to apply a first joint/DL TCI state, a second joint/DL TCI state, both, or none of the joint/DL (e.g., unified) TCI states indicated by DCI or MAC-CE to a CORESET or to a group of CORESET(s). In an example, the first joint/DL (e.g., unified) TCI state (e.g., indicated by DCI or MAC-CE) may correspond to the first TCI state instance e.g., among the currently used unified TCI(s) indicated by a TCI field of a DCI. The second joint/DL (e.g., unified) TCI states (e.g., indicated by DCI or MAC-CE) may correspond to the second TCI state instance, e.g., among the currently used unified TCI(s) indicated by a TCI field of a DCI.

The WTRU may receive a DCI comprising a TCI field indicating a TCI value (or codepoint), for example, as shown by Value2 in FIG. 11. The WTRU may determine whether the indicated TCI value (e.g., Value2) is associated with one TCI state or whether the indicated TCI value (e.g., Value2) is associated with more than one TCI state. In an example, if the WTRU determines that the indicated TCI value is associated with one TCI state, the WTRU may use the one indicated TCI state for receiving a PDSCH and/or monitoring a second (e.g., later) PDCCH. If the UE determines that the indicated TCI value is associated with more than one TCI state (e.g., two TCI states), the WTRU may use the more than one TCI states for receiving a PDSCH, and the WTRU may use one or more of the more than one TCI states, based on the received information (e.g., by a parameter of “PDCCH TCI state usage”) for monitoring a second (e.g., later) PDCCH.

The WTRU may, e.g., based on the received information (e.g., by a parameter of “PDCCH TCI state usage”), monitor for a physical downlink control channel (PDCCH) transmission via the first CORESET and/or the second CORESET. A first TCI state may be used to monitor for the PDCCH transmission in the first CORESET, for example, when the TCI value indicates the first TCI state is associated with the first TCI state instance and when the first CORESET is associated with the first TCI state instance. A second TCI state may be used to monitor for the PDCCH transmission in the second CORESET, for example, when the TCI value indicates the second TCI state is associated with the second TCI state instance and when the second CORESET is associated with the second TCI state instance.

The WTRU may receive information associating the TCI value with one or more of the first TCI state for the first TCI state instance or the second TCI state for the second TCI state instance (e.g., in a MAC CE). The WTRU may receive information (e.g., RRC, by a parameter of “PDCCH TCI state usage” as shown in the figure) indicating that the first CORESET may be associated with the first TCI state instance and/or the second CORESET may be associated with the second TCI state instance.

In an example, RRC can configure the Unified TCI state instance applicable to certain PDSCH receptions. For instance, the configuration may be provided for semi-persistently scheduled (SPS) PDSCH. The configuration may be specific to each SPS configuration or common to all SPS configurations. In an embodiment, RRC may configure the Unified TCI state instance to certain non-zero-power (NZP) CSI-RS receptions. For example, RRC may configure the Unified TCI state instance for one or more NZP CSI-RS resource listed in an associated CSI report configuration of an aperiodic CSI trigger state. For example, RRC may configure the Unified TCI state instance for one or more periodic NZP CSI-RS resource. Such configuration, for example, may be included as part of the configuration of the NZP CSI-RS resource itself. In an example, the Unified TCI state may be configured as part of the CSI report configuration. In the latter case, such configuration may supersede a TCI state configured within the NZP CSI-RS resource, if any.

The WTRU may receive MAC CE or DCI signaling indicating a Unified TCI state instance for one or more of: at least one PUCCH resource corresponding to a PUCCH resource index, a PUCCH configuration index, a HARQ-ACK codebook, an SR resource configuration, and/or a CSI report configuration; at least one SRS resource or SRS resource set; at least one CG configuration or SPS configuration; at least one Coreset, where the at least one Coreset may be identified by at least one Coreset ID or may include all Coresets with a configured Coreset Pool index; at least one DCI format, DCI size and/or search space; and at least one NZP CSI-RS. For example, a MAC CE activating at least one semi-persistent NZP CSI-RS resource may indicate a Unified TCI state instance for each of the at least one resource. The DCI signaling may consist of at least one indication by DCI.

In some examples, a DCI field may explicitly indicate the applicable Unified TCI state instance for a transmission or reception indicated by the DCI. The DCI field may be a new field dedicated to this indication, or an existing field also used to indicate other information. For example, each possible value of a TCI field may indicate one of a combination of a Unified TCI state instance and an index to a TCI state. For example, the WTRU may receive a DCI indicating a Unified TCI state instance and possibly a TCI state index. The WTRU may determine an applicable Coreset or Coreset Pool index based on an explicit indication from the DCI or implicitly from the Coreset that was used for decoding the PDCCH. The WTRU may apply the Unified TCI state instance and possibly TCI state index to subsequent receptions of PDCCH using a Coreset with the determined Coreset index or Coreset Pool Index, possibly after a fixed delay. For example, the WTRU may receive a DCI indicating a PUSCH or a set of PUSCH repetitions and including an SRS resource indicator and/or an SRS resource set indicator. The WTRU may determine an SRS resource set and/or SRS resource for the PUSCH or for each PUSCH repetition using a legacy solution. The WTRU may determine the applicable Unified TCI state instance for the PUSCH or for each PUSCH repetition as the Unified TCI state instance configured for the SRS resource set and/or SRS resource determined for the respective PUSCH or PUSCH repetition.

In an example, the WTRU may first receive signaling providing a Unified TCI state instance for each configured TCI state or each activated TCI state. Such signaling may be by RRC, MAC CE and/or DCI. For example, RRC may configure an IE indicating a Unified TCI state instance for each TCI state, or RRC may provide first and second sets of TCI states corresponding to first and second Unified TCI state instance, respectively. For example, MAC CE may include a Unified TCI state instance in a MAC CE activating and/or deactivating TCI states, such that all activated TCI states are associated to this Unified TCI state instance. In an example, upon reception of DCI including a TCI state field, the WTRU may determine that the applicable and/or indicated Unified TCI state for the DCI corresponds to the Unified TCI state associated to the indicated TCI state. In an example, for one or more TCI state, the WTRU may receive no configuration or indication of a Unified TCI state instance. In this case, the WTRU may assume that this TCI state corresponds to a default Unified TCI state instance. In an example, the WTRU may determine that this TCI state is independent of any Unified TCI state instance. In an example, the WTRU may receive a DCI with a time-domain resource allocation field indicating that PDSCH is repeated K times. The WTRU may determine a Unified TCI state instance for each repetition based on a configured pattern. For example, the WTRU may be configured to apply a cyclic mapping. The Unified TCI state instance may, for example, be incremented for each PDSCH repetition (for example, modulating the number of Unified TCI state instances).

In some examples, the WTRU may determine an applicable Unified TCI state instance from a property of the grant or assignment. For instance, RRC and/or MAC CE may first indicate or configure a Unified TCI state instance for each possible value of a priority index. The WTRU may determine that the Unified TCI state instance applicable to a PUSCH or PUCCH is the Unified TCI state instance configured or indicated for this priority index. In an example, RRC and/or MAC CE can first indicate or configure a Unified TCI state instance for each possible value of a bandwidth part indication. The WTRU may determine that the Unified TCI state instance applicable to a PUSCH or PUCCH is the Unified TCI state instance configured or indicated for this bandwidth part indication. In an example, the WTRU may determine (e.g., implicitly determine) that a Unified TCI state instance applicable to a first transmission or reception corresponds to a Unified TCI state instance applicable to a second transmission or reception. For example, the Unified TCI state instance applicable to a PDSCH reception, a PUSCH transmission, and/or a PUCCH transmission may correspond to the Unified TCI state instance applicable to the indicating PDCCH and/or latest indicating PDCCH. For example, the Unified TCI state instance applicable to a PUCCH transmission for HARQ-ACK may correspond to the Unified TCI state instance applicable to the corresponding PDSCH and/or latest PDSCH. In an example, the WTRU may receive signaling indicating applicable Unified TCI state instance for a set of symbols and/or slots. The signaling may consist of RRC signaling or DCI (such as group-common DCI) and may consist of an indication of a time pattern (for example, signaled as bitmap) for which an indicated Unified TCI state is applicable. The WTRU may apply a unified TCI state instance to a transmission or reception if it completely overlaps with the indicated time pattern for this unified TCI state instance.

In an example, the WTRU may receive signaling indicating applicable Unified TCI state instance for a set of resource blocks. The signaling may consist of RRC signaling or DCI (such as, for example, group-common DCI) and may consist of an indication of at least one range of RBs or a subset of RBs for which an indicated Unified TCI state is applicable. The WTRU may apply a unified TCI state instance to a transmission or reception if it completely overlaps with the indicated subset of RBs for this unified TCI state instance. In an example, the WTRU may determine whether to apply a Unified TCI state instance for a transmission or reception based on an indication by DCI. For example, if the WTRU receives one of a pre-defined or configured subset of values for the TCI field of a DCI, the WTRU may determine that there is no applicable Unified TCI state instance for the indicated PDSCH. The WTRU may apply the indicated TCI state(s) to PDSCH indicated by this DCI, and may or may not affect subsequent transmissions or receptions. In an example, if the WTRU receives one of a pre-defined or configured subset of values for the SRS resource indicator or SRS resource set indicator field, the WTRU may apply the indicated SRS resource or SRS resource set, and may or may not affect subsequent transmissions and/or receptions. In an example, the WTRU may receive signaling indicating a TCI state corresponding to a Unified TCI state instance. The WTRU applies this TCI state to subsequent transmissions or receptions for which this Unified TCI state is applicable, if any. In an example, if the signaling indicates that the TCI state corresponding to a Unified TCI state instance is changed, the WTRU may apply the change N symbols after reception of the signaling (for example, end of last symbol) or transmission of its acknowledgment. The value of N may depend on the subcarrier spacing and type of transmission or reception. In an example, if no Unified TCI state instance is applicable, subsequent transmissions and/or receptions may not be affected. In an example, the signaling indicating a TCI state for a Unified TCI state instance may consist of one or more of: a DCI indicating a PDSCH or PUSCH. For example, the WTRU may determine a TCI state from the TCI field for a DCI indicating PDSCH; DCI without assignment or grant. For example, the CRC of such DCI may be scrambled with a specific RNTI (e.g. CS-RNTI and/or the like) and have pre-defined values for certain DCI fields. Such DCI may, for example, be referred to as a TCI state update.

In some examples, the WTRU may determine the Unified TCI state instance for the signaling using any of the solutions outlined in earlier paragraphs. For example, the WTRU may determine the Unified TCI state instance as the Coreset pool ID of the Coreset from which PDCCH is decoded. In an example, the WTRU may determine the Unified TCI state instance from a field of the DCI. In an example, the WTRU may determine the Unified TCI state instance as the Unified TCI state associated to the indicated TCI state based on RRC configuration and/or MAC CE.

A beam failure recovery (BFR) procedure may be initiated, performed, conducted, and/or triggered) by the WTRU, for example, based on determining and/or detecting a communication link (for example, between the WTRU and a gNB) quality is under a threshold value. The communication link quality may be determined, pre-defined, configured, and/or indicated based on one or more CORESETs configured to the WTRU. The threshold value may be pre-configured (for example, via RRC) to the WTRU and/or indicated. The threshold value may be based on a RSRP value (for example, Layer-1 RSRP value/metric), a SINR value (for example, Layer-1 SINR value/metric), bit error rate (BER), block error rate (BLER), hypothetical BLER (for example, based on RSRP and/or SINR), and/or the like. The WTRU may be configured to initiate a first BFR procedure for a first communication link between the WTRU and a first TRP (for example, RRH, TP, RP, gNB, cell), e.g., based on detecting the first communication link quality is under a threshold value. The WTRU may further detect that a signal and/or channel quality of a second communication link between the WTRU and a second TRP is under a threshold value. In response to the detecting, the WTRU may initiate a second BFR procedure for the second communication link, e.g., while the first BFR procedure is being performed (for example, in parallel, as an independent BFR procedure). The independent BFR procedures for the first BFR procedure and the second BFR procedure may increase a latency in completing a recovery of all (failed) beams.

The independent BFR procedures may degrade a reliability of maintaining one or more communication links, e.g., where the WTRU may detect an event of Maximum Permissible Exposure (MPE) and the WTRU may experience, detect, and/or determine both of a first signal/channel quality of the first communication link and a second signal and/or channel quality of the second communication link are all under a threshold value (for example, may be simultaneously under a threshold value), based on, because of, and/or due to the event of MPE. The event of MPE may refer to an event that the WTRU may experience an excessive signal and/or channel power (for example, over a threshold) on a certain direction that may be harmful for a user using the WTRU. The WTRU may experience both of the first and second signal/channel qualities are under a threshold value, for example, based on the event of MPE having occurred.

In some examples, the WTRU may be configured to initiate a simultaneous-BFR procedure (for example, MTRP-simultaneous-BFR procedure), where the simultaneous-BFR procedure may imply and/or refer to, for the WTRU to initiate, conduct, perform, and/or do more than one BFR procedure (e.g., each corresponding to a communication link between the WTRU and a TRP (and/or for a CC/BWP), and the like) simultaneously. Hereafter, for the brevity of discussion, the more than one BFR procedure (of the simultaneous-BFR procedure) may comprise a first one for TRP1 and a second one for TRP2, however the proposed solutions and processes may equally be employed for cases with more than 2 TRPs being applied based on the simultaneous-BFR procedure. In an example, one of the TRPs may be the primary TRP (for example, TRP1).

The WTRU may be configured with more than one beam failure detection (BFD) RS set, based on the simultaneous-BFR procedure (for example, being configured by a gNB). In an example, the WTRU may be configured with a first q0 set (as a first BFD RS set from TRP1) comprising one or more RSs (for example, RS1a and RS1b) configured in the first q0 set, and a second q0 set (as a second BFD RS set from TRP2) comprising one or more RSs (for example, RS2a and RS2b). A physical layer in the WTRU may provide an indication of the (MTRP-) simultaneous-BFR procedure to higher layers, based on and/or in response to determining a radio link quality for one or more RSs (e.g., all RSs, all corresponding resource configurations) of at least one of the first q0 set and the second q0 set, e.g., which the WTRU uses to determine and/or assess that the radio link quality is worse than a threshold (e.g., a threshold parameter of Qout,LR). In some examples, the threshold (for example, Qout,LR) value may be configured (for example, independently configured) for each TRP, for example, Qout,LR1 for TRP1 and Qout,LR2 for TRP2, which may provide benefits in terms of flexibility and efficiency, in that each TRP may have a different priority level of being initiated by a BFR procedure, e.g., TRP1 may have a higher priority as a primary TRP for the WTRU which may have a higher value of the threshold, while TRP2 as a secondary TRP may have a lower value of the threshold.

The WTRU may be configured with (and/or have a pre-defined rule for) one or more conditions to initiate, trigger, perform, conduct, and/or do the (MTRP-) simultaneous-BFR procedure, for example, based on at least one configuration and/or parameter for unified TCI(s) being applied to the WTRU. In an embodiment, an example condition may be if all beams at TRP1 (for example, the primary TRP) failed, and partial and/or at least one beam at TRP2 failed. In an embodiment, an example condition may be if all beams at TRP1 (for example, the primary TRP) failed, and regardless of other TRP beam status (for example, as a proactive MTRP-simultaneous-BFR). In an embodiment, an example condition may be if partial and/or at least one beam at TRP1 (for example, the primary TRP) failed, and partial and/or at least one beam at TRP2 failed. In an embodiment, an example condition may be if partial and/or at least one beam at TRP1 (for example, the primary TRP) failed, and regardless of other TRP beam status (for example, as a proactive MTRP-simultaneous-BFR). In an example, based on the proactive MTRP-simultaneous-BFR, robustness and quality of communication link(s) between the gNB (for example, employing TRP1 and TRP2) and the WTRU may be increased, for example, because an initiation of the simultaneous-BFR procedure may not wait for (e.g., be delayed until) more stringent condition(s) are met (for example, all beam failed, at least one TRP's all beams failed, or the like).

The WTRU may apply two or more BFD-counters (e.g., based on the MTRP-simultaneous-BFR procedure), based on at least two of the following being met: BFD-Counter1 (e.g., only for checking the primary TRP status, e.g., TRP1 (on BFD condition(s) was being met or not), which may be running when a first set of condition(s) being met); BFD-Counter2 (e.g., only for checking the secondary TRP status, e.g., TRP2, (on BFD condition(s) was being met or not), which may be running when a second set of condition(s) was being met); BFD-Counter3 (e.g., for checking both and/or all MTRP status, which may be running when a third set of condition(s) was being met). In an example, based on the MTRP-simultaneous-BFR procedure, the WTRU may apply two or more thresholds (for example, CounterThresholds, BFD-Counter Thresholds, and/or the like). For example, the WTRU may apply threshold based on CounterThreshold1 (for example, set as 10, and/or consecutively over measured samples), when at least the primary TRP's beam(s) may have failed. A higher priority for the primary TRP may be given and applied, which may increase flexibility, efficiency, and/or performance in terms of network implementation that a gNB may set a TRP as a higher-priority for communication with the WTRU. For example, the WTRU may apply threshold based on CounterThreshold2 (for example, set as 20, e.g., and/or consecutively over measured samples) when other than the primary TRP's beam(s) failed. Lower priority for the other TRP(s) may be given and/or applied, which may increase flexibility, efficiency, and/or performance in terms of network implementation that a gNB may set a TRP as a higher-priority for communication with the WTRU.

The WTRU may be configured with a candidate beam index (e.g., q_new) being associated with more than one beam (e.g., as a paired beam information for MTRP-BFR, e.g., each of the paired beams corresponding to each TRP), for example, based on the MTRP-simultaneous-BFR procedure. In an example, a PRACH resource (which may, for example, be a common resource) associated with a multi-beam pair may be configured/indicated to the WTRU, for example, where each beam comprised in the multi-beam pair may corresponds to each TRP. For example, resource overhead may be conserved in configuring PRACH resource(s) for BFR procedures for MTRP, for example, based on MTRP-simultaneous-BFR procedure, and/or benefits in terms of network implementation flexibility and efficiency in that gNB may configure a preferred multi-beam pair (for example, q_new1 and q_new2) on a single PRACH resource.

The WTRU may transmit (or for example be configured to transmit) a BFR-request (BFRR) message for the MTRP-simultaneous-BFR procedure, for example, based on and/or by using the PRACH resource (which may, for example, be a common PRACH resource) associated with a multi-beam pair, when at least one BFRR-condition is met, which comprises: BFRR-Condition1 for a stringent condition to transmit a BFRR, e.g., based on all beams being failed for TRP1 (for example, as a primary TRP) and partial BFR for TRP2; BFRR-Condition2 for mainly considering a primary TRP's condition, for example, based on all beams being failed for TRP1 (for example, as a primary TRP) and regardless of other TRP); and BFRR-Condition3 for a relaxed condition for MTRP, e.g., based on partial BFR for TRP1 and partial BFR for TRP2. In an example, the WTRU may transmit, and/or be configured to transmit, a BFR-request (BFRR) message for the MTRP-simultaneous-BFR procedure, e.g., based on (by using) an uplink resource (for example, PUCCH, scheduling request (SR), MAC-CE via a PUSCH, etc.) that may or may not be a PRACH resource, e.g., when at least one communication link (for example, between a TRP and the WTRU) is alive (e.g., is not above a threshold, is not completely failed, etc.) and/or when not satisfying one or more, or any of, the above BFRR-condition(s).

The WTRU may be configured with a BFR-CORESET, for example, based on the MTRP-simultaneous-BFR procedure (e.g., which may be common and/or shared) for M-TRPs, via which a response message from a gNB may be received to the WTRU, in response to a BFRR message transmitted by the WTRU. This may provide benefits that resource overhead may be saved in configuring multiple BFR-CORESETs for M-TRP, based on that the configuration number of CORESETs per BWP may be limited in terms of network implementation and efficient operation. Configuring multiple BFR-CORESETs may not be efficient in that the beam for a BFR-CORESET may not be necessary to be configured initially.

The WTRU may determine a first beam index (for example, q_new1), e.g., associated with TRP1, in response to a BFD condition being met, and may transmit a first BFRR message indicating/comprising the first beam index, e.g., where a first PRACH (or, for example, PUCCH/SR/MAC-CE, and the like) resource may be used for transmitting the first BFRR message. In response to determining the first beam index (and transmitting the first BFRR message), the WTRU may determine, assume, and/or identify a beam (for example, TCI, unified TCI, and/or the like) for the BFR-CORESET (which may be common and/or shared) is based on, is identical to, is the same as, is equivalent to, becomes, and/or other like relationships to, the first beam index, e.g., being used by TRP1. The WTRU may monitor a downlink signal (for example, a DCI, a control channel information content), via the BFR-CORESET (which may be common and/or shared among multiple TRPs), using a first spatial(-domain) filter determined based on the first beam index. This may provide benefits that resource overhead may be saved/reduced based on using the BFR-CORESET (which may be common and/or shared) for M-TRPs and its beam being determined by the WTRU's transmission of BFRR message (for example, associated with the first beam index), instead of configuring multiple BFR-CORESETs initially.

The WTRU may determine a second beam index (for example, q_new2), e.g., associated with TRP2, in response to a BFD condition being met, and may transmit a second BFRR message indicating/comprising the second beam index, e.g., where a second PRACH (or for example, PUCCH, SR, MAC-CE, and/or the like) resource may be used for transmitting the second BFRR message. In response to determining the second beam index and/or transmitting the second BFRR message, the WTRU may determine, assume, and/or identify a beam (for example, TCI, unified TCI, and/or the like) for the BFR-CORESET (which may be common and/or shared) is based on, is identical to, is the same as, is equivalent to, becomes, and/or a like relationship to, the second beam index, e.g., being used by TRP2. The WTRU may monitor a downlink signal (for example, a DCI, a control channel information content), via the BFR-CORESET (which may be common and/or shared), using a second spatial (-domain) filter determined based on the second beam index. This may provide benefits that resource overhead may be saved/reduced based on using the BFR-CORESET (which may be common and/or shared) for M-TRPs and its beam being determined by the WTRU's transmission of BFRR message (for example, associated with the second beam index), instead of configuring multiple BFR-CORESETs initially.

The WTRU may be configured with more than one recovery-search space associated with the BFR-CORESET, for example, based on the MTRP-simultaneous-BFR procedure (which may be common and/or shared) for M-TRPs. In an example, a first recovery search space for monitoring a BFR response (for example, DCI1, e.g., transmitted from TRP1) and a second recovery search space for monitoring a BFR response (for example, DCI2, e.g., transmitted from TRP2) may be configured and/or activated, and/or one or both being associated with the BFR-CORESET (which may be common and/or shared for the M-TRPs). In an example, in response to receiving the DCI1 via the first recovery search space, the WTRU may determine that at least a q_new1 (for example, not q_new2, even though being reported by the WTRU) may be applied and/or become as the beam for the BFR-CORESET (which may be common and/or shared). In an example, in response to receiving the DCI2 via the second recovery search space, the WTRU may determine that at least a q_new2 (for example, not q_new1, even though being reported by the WTRU) may be applied and/or become as the beam for the BFR-CORESET (which may be common and/or shared). This may provide benefits that resource overhead may be saved/reduced based on using the BFR-CORESET (which may be common and/or shared) for M-TRPs and its beam being determined by the WTRU's transmission of BFRR message (for example, associated with q_new1 or q_new2, etc.), instead of configuring multiple BFR-CORESETs initially.

The WTRU may receive a response message, for example, based on the (MTRP-) simultaneous-BFR procedure (e.g., the BFR response) from a gNB, in response to a BFRR message transmitted by the WTRU. The response message may comprise one or more information blocks (e.g., block-wise information, e.g., similar to or being shared with a DCI (format 2 and/or 3) for group-wise power control commands), where a first block of the one or more information blocks may comprise a first BFR response from TRP1 and a second block of the one or more information blocks may comprise a second BFR response from TRP2. The block-wise information may further comprise a block (e.g., a third BFR response, etc.) for a different BWP and/or CC. In an example, the first BFR response and the second BFR response may be for a first BWP and/or CC based on a BWP and/or CC indicator (e.g., a first BWP and/or CC indicator), and the third BFR response may be for a second BWP and/or CC based on a BWP and/or CC indicator (e.g., a second BWP and/or CC indicator).

The WTRU may receive a confirmation message, for example, based on the (MTRP-) simultaneous-BFR procedure (which may be a common and/or a single confirmation message) for both q_new1 and q_new2 by a single DCI (e.g., as a BFR-response-DCI, via a BFR-CORESET) indicating (e.g., comprising) unified TCI(s). In response to receiving the single DCI (e.g., based on the (MTRP-) simultaneous-BFR procedure and/or mode being configured/indicated), the WTRU may (and/or be configured to) re-interpret for a (for example, special and/or default) codepoint (e.g., 000) of a TCI field in the single DCI, where the special/default codepoint is to be automatically re-described and/or overridden into the q_new1 and/or q_new2 (for example, instead of the current description/mapping of the special codepoint, e.g., given by a previous MAC-CE message). In an example, the WTRU may apply the re-describing/overriding that the special and/or default codepoint indicates, and/or becomes to indicate, the q_new1 and/or q_new2, in response to determining (only) that the q_new1 and/or q_new2 are not, are not included, are not described, are not comprised, are not associated, are not indicated, and/or other like relationship to, in any codepoint(s), which may be a current codepoint, (for example, codepoint 000, 001, . . . 111, if 3-bit TCI field, etc.) of the TCI field.

The WTRU may not apply the re-describing and/or overriding that the special and/or default codepoint indicates, and/or will indicate, the q_new1 and/or q_new2, in response to determining that the q_new1 and/or q_new2 are (for example, already) included, described, comprised, associated, and/or indicated in a (for example, current) codepoint(s) (e.g., among codepoint 000, 001, . . . 111, if 3-bit TCI field, etc.) of the TCI field. In an example, the WTRU may determine that the q_new1 is (for example, already) included, described, comprised, associated, or indicated in a (for example, current) codepoint 001 of the TCI field, the gNB may transmit a DCI (e.g., as a BFR-response-DCI, via a BFR-CORESET) comprising the TCI field, for example, based on the q_new1 being (for example, already) in the codepoint 001, by indicating a codepoint 001 of the TCI field. In response to receiving the DCI at the WTRU, the WTRU may apply the q_new1 (e.g., indicated by the codepoint 001) as a (e.g., new) unified TCI (e.g., to be applied/used as a beam/TCI for multiple channels and/or signals), e.g., for communications (for example, via uplink and/or downlink) with TRP1.

The WTRU may determine that the q_new2 is (already) included, described, comprised, associated, or indicated in a (e.g., current) codepoint ‘011’ of the TCI field, the gNB may transmit a DCI (e.g., as a BFR-response-DCI, via a BFR-CORESET) comprising the TCI field, for example, based on that the q_new2 is (already) in the codepoint ‘011’, by indicating a codepoint ‘011’ of the TCI field. In response to receiving the DCI at the WTRU, the WTRU may apply the q_new2 (for example, indicated by the codepoint 011) as a (for example, new) unified TCI (for example, to be applied/used as a beam/TCI for multiple channels/signals), e.g., for communications (for example, via uplink and/or downlink) with TRP2. In an example, the WTRU may determine that the q_new1 and q_new2 are (for example, already) included, described, comprised, associated, or indicated in a (for example, current) codepoint ‘101’ of the TCI field. The gNB may transmit a DCI (for example, as a BFR-response-DCI, via a BFR-CORESET) comprising the TCI field, for example, based on that the q_new1 and q_new2 are (for example, already) in the codepoint ‘101’, by indicating a codepoint ‘101’ of the TCI field.

In response to receiving the DCI at the WTRU, the WTRU may apply the q_new1 and q_new2 (for example, indicated by the codepoint 101) as (for example, new) unified TCIs (for example, the q_new1 to be applied/used as a first beam and/or TCI for multiple channels/signals for communications (via uplink and/or downlink) with TRP1, and the q_new2 to be applied/used as a second beam/TCI for multiple channels/signals for communications (for example, via uplink and/or downlink) with TRP2). In one example, the WTRU may not expect to receive (e.g., the gNB should not transmit, or the gNB is not allowed to transmit) the DCI (via the BFR-CORESET, e.g., as a BFR-response-DCI, based on the (MTRP-) simultaneous-BFR procedure) indicating a second codepoint not associated (at all) with q_new1 and/or q_new2.

The WTRU may receive a first BFR-response (for example, DCI1) ase, for example, based on the (MTRP-) simultaneous-BFR procedure, via a first BFR-CORESET (e.g., BFR-CORESET #1) from TRP1, e.g., after transmitting a first BFRR message associated with a first beam index (for example, q_new1). In response to receiving the first BFR-response, the WTRU may apply, determine, and/or update the q_new1 being set to a first position of (for example, behavior) description for each of one or more, or all, codepoints of a TCI field of a DCI for indicating unified TCI(s). Other position (e.g., a second position) of the behavior description for each of the one or more codepoints may remain unchanged. In an example, for a first codepoint of the TCI field, where a behavior description of the first codepoint is currently mapped (e.g., described) as ‘TCI ID #X, TCI ID #Y’, e.g., via a MAC-CE, the WTRU may re-map (e.g., re-describe) a first position of the behavior description (which is TCI ID #X) being updated to be the q_new1. The second position of the behavior description (which is TCI ID #Y) may remain unchanged, e.g., then the first codepoint may now be described as ‘the q_new1, TCI ID #Y’ as a codepoint to be applicable for an indication of unified TCI(s) (e.g., for M-TRPs). This may provide benefits in terms of overhead and latency reduction on indicating unified TCIs based on codepoint descriptions (e.g., which may be automatically updated/activated/indicated in response to receiving the first BFR-response, based on the (MTRP-) simultaneous-BFR procedure), instead of updating the behavior description on a codepoint via a MAC-CE.

The WTRU may receive a second BFR-response (e.g., DCI2) via a second BFR-CORESET (e.g., BFR-CORESET #2) from TRP2, for example, based on the (MTRP-) simultaneous-BFR procedure, e.g., after transmitting a second BFRR message associated with a second beam index (e.g., q_new2). In response to receiving the second BFR-response, the WTRU may apply (e.g., determine, update) the q_new2 being set to a second position of (behavior) description for each of one or more (or all) codepoints of a TCI field of a DCI for indicating unified TCI(s). Other position (e.g., a first position) of the behavior description for each of the one or more codepoints may remain unchanged. In an example, for a second codepoint of the TCI field, where a behavior description of the second codepoint is currently mapped (e.g., described) as ‘TCI ID #A, TCI ID #B’, e.g., via a MAC-CE, the WTRU may re-map (e.g., re-describe) a second position of the behavior description (which is TCI ID #B) being updated to be the q_new2. The first position of the behavior description (which is TCI ID #A) may remain unchanged, e.g., then the second codepoint may now be described as ‘TCI ID #A, the q_new2’ as a codepoint to be applicable for an indication of unified TCI(s) (e.g., for M-TRPs). This may provide benefits in terms of overhead and latency reduction on indicating unified TCIs based on codepoint descriptions (e.g., which may be automatically updated/activated/indicated in response to receiving the second BFR-response, based on the (MTRP-) simultaneous-BFR procedure), instead of updating the behavior description on a codepoint via a MAC-CE. It may be configured/indicated (e.g., be configurable) from a gNB (e.g., via an RRC and/or a MAC-CE) whether first one or more codepoints of a first TCI field of the DCI1 (for example, via the first BFR-CORESET from TRP1) and second one or more codepoints of a second TCI field of the DCI2 (for example, via the second BFR-CORESET from TRP2) are shared each other, or not.

In response to receiving a control command from the gNB that the first one or more codepoints of a first TCI field of the DCI1 (for example, via the first BFR-CORESET from TRP1) and the second one or more codepoints of a second TCI field of the DCI2 (for example, via the second BFR-CORESET from TRP2) are shared each other, the result of the re-mapping (e.g., re-describing) behavior on one or more codepoints of the first TCI field of a first DCI may be used for a next re-mapping (e.g., re-describing) behavior (e.g., on one or more codepoints of the second TCI field of a second DCI) occurred by a next reception of a DCI (e.g., the second DCI) as a BFR-response. In an example, based on the first codepoint of the TCI field of the DCI1 being updated as the q_new1, TCI ID #Y, in response to receiving the DCI2 indicating the first codepoint (for example, again), the WTRU may re-map (e.g., re-describe) the second position of the behavior description (which is currently TCI ID #Y) being updated to be the q_new2. The first position of the behavior description (which is currently the q_new1) may remain unchanged, e.g., then the (for example, shared) first codepoint may now be described as ‘the q_new1, the q_new2’ as a codepoint to be applicable for an indication of unified TCI(s) (e.g., for M-TRPs). This may provide benefits in terms of overhead and latency reduction on indicating unified TCIs based on codepoint descriptions (e.g., which may be automatically updated/activated/indicated in response to receiving a BFR-response, based on the (MTRP-) simultaneous-BFR procedure), instead of updating the behavior description on a codepoint via a MAC-CE.

The WTRU may receive separated configurations of BFR-related parameter(s) for each TRP, for example, based on the (MTRP-) simultaneous-BFR procedure. For example, the BFR-related parameter(s) may comprise at least one of: rootSequenceIndex-BFR; rach-ConfigBFR; rsrp-ThresholdSSB; candidateBeamRSList (e.g., comprising q_new1, q_new2, . . . ); ssb-perRACH-Occasion; ra-ssb-OccasionMaskIndex; recoverySearchSpaceld; ra-Prioritization; beamFailureRecoveryTimer; powerRampingStep (e.g., power-ramping factor, PREAMBLE_POWER_RAMPING_STEP); and PREAMBLE_POWER_RAMPING_COUNTER. In an example, at least one parameter in a MAC-CE for RACH-BFR may be configured/indicated separately per TRP (and/or per unified TCI pool). In an example, the powerRampingStep of the at least one parameter may be configured/indicated separately per TRP, which may provide benefits in that more aggressive power ramping steps for a first TRP (e.g., a TRP based on latency-critical traffic) may be applied at the WTRU (e.g., based on gNB's indication/configuration) and less aggressive power ramping steps for a second TRP (e.g., a TRP based on other traffic) may be applied at the WTRU (e.g., based on gNB's indication/configuration).

What is claimed is:

1.-16. (canceled)

17. A wireless transmit/receive unit (WTRU) comprising a processor configured to:
receive information indicating a list of component carriers (CCs), where the list of CCs comprises at least a first CC and a second CC, and wherein the information comprises an indicator associating the first CC with a first transmission configuration indicator (TCI) state position or a second TCI state position of an ordered set of TCI state positions associated with the second CC;
receive downlink control information (DCI), wherein the DCI comprises a TCI field value;
determine whether the TCI field value indicates a first TCI state in the first TCI state position or a second TCI state in the second TCI state position of the ordered set of TCI state positions;
determine, based on the indicator, a TCI state for a first uplink (UL) transmission sent via the first CC;
determine, based on the TCI field value, a TCI state for a second UL transmission sent via the second CC; and
transmit the first UL transmission and the second UL transmission using the determined TCI states.

18. The WTRU of claim 17, wherein the processor being configured to determine the TCI state for the first UL transmission based on the indicator comprises the processor being configured to:
on a condition that the indicator indicates the first TCI state position, apply the first TCI state to the first UL transmission; and
on a condition that the indicator indicates the second TCI state position, apply the second TCI state to the first UL transmission.

19. The WTRU of claim 17, wherein the first CC is associated with a first transmission-reception point (TRP) and the second CC is associated with at least a second TRP and a third TRP.

20. The WTRU of claim 17, wherein the processor is configured to receive the DCI via the second CC.

21. The WTRU of claim 19, wherein the first UL transmission is sent to the first TRP.

22. The WTRU of claim 19, wherein the processor is further configured to determine, based on the TCI field value, whether to send the second UL transmission to the second TRP or the third TRP.

23. The WTRU of claim 17, wherein the information is received via a Medium Access Control (MAC) Control Element (CE).

24. The WTRU of claim 17, wherein the first UL transmission is a first physical uplink control channel (PUCCH) transmission, a first physical uplink shared channel (PUSCH) transmission, or a first sounding reference signal (SRS) transmission, and wherein the second UL transmission is a second PUCCH transmission, a second PUSCH transmission, or a second SRS transmission.

25. The WTRU of claim 17, wherein the list of CCs is for a common TCI state identity activation or update.

26. A method implemented in a wireless transmit/receive unit (WTRU), the method comprising:
receiving information indicating a list of component carriers (CCs), where the list of CCs comprises at least a first CC and a second CC, and wherein the information comprises an indicator associating the first CC with a first transmission configuration indicator (TCI) state position or a second TCI state position of an ordered set of TCI state positions associated with the second CC;
receiving downlink control information (DCI), wherein the DCI comprises a TCI field value;
determining whether the TCI field value indicates a first TCI state in the first TCI state position or a second TCI state in the second TCI state position of the ordered set of TCI state positions;
determining, based on the indicator, a TCI state for a first uplink (UL) transmission sent via the first CC;
determining, based on the TCI field value, a TCI state for a second UL transmission sent via the second CC; and
transmitting the first UL transmission and the second UL transmission using the determined TCI states.

27. The method of claim 26, further comprising determining the TCI state for the first UL transmission based on the indicator:
on a condition that the indicator indicates the first TCI state position, apply the first TCI state to the first UL transmission; and
on a condition that the indicator indicates the second TCI state position, apply the second TCI state to the first UL transmission.

28. The method of claim 17, wherein the first CC is associated with a first transmission-reception point (TRP) and the second CC is associated with at least a second TRP and a third TRP.

29. The method of claim 17, further comprising receiving the DCI via the second CC.

30. The method of claim 28, wherein the first UL transmission is sent to the first TRP.

31. The method of claim 28, further comprising determining, based on the TCI field value, whether to send the second UL transmission to the second TRP or the third TRP.

32. The method of claim 26, further comprising receiving the information via a Medium Access Control (MAC) Control Element (CE).

33. The method of claim 26, wherein the first UL transmission is a first physical uplink control channel (PUCCH) transmission, a first physical uplink shared channel (PUSCH) transmission, or a first sounding reference signal (SRS) transmission, and wherein the second UL transmission is a second PUCCH transmission, a second PUSCH transmission, or a second SRS transmission.

34. The method of claim 26, wherein the list of CCs is for a common TCI state identity activation or update.
